(19) United States
(12) Patent Application Publication
(10) Pub. No.: US 2025/0341618 A1
(43) Pub. Date: Nov. 6, 2025

(54) PHOTODETECTION ELEMENT AND ELECTRONIC DEVICE

(71) Applicant: Sony Semiconductor Solutions Corporation, Kanagawa (JP)

(72) Inventor: Kyoji Mizoguchi, Kanagawa (JP)

(21) Appl. No.: 18/877,593

(22) PCT Filed: Jun. 22, 2023
(86) PCT No.: PCT/JP23/23077

§ 371 Date: Dec. 20, 2024

(30) Foreign Application Priority Data
Aug. 8, 2022 (JP) 2022-126629

(51) Int. Cl. G01S 7/4861; G01S 7/481; G01S 7/4865

(52) U.S. Cl. CPC G01S 7/4861; G01S 7/4816; G01S 7/4865

(57) ABSTRACT

Photodetection elements and electronic devices with low power consumption in event detection are disclosed. In one example, a photodetection element includes a pixel array, a holding circuit, a control circuit, and a signal processing circuit. In the pixel array, event detection elements that detect an intensity difference of received light are arranged in a two-dimensional array. The holding circuit holds an event detected by the event detection elements. The control circuit controls a power supply voltage and a clock signal for the event detection element belonging to at least a partial region of the pixel array and the holding circuit corresponding to the event detection element. The signal processing circuit processes a signal output from the event detection element.

### TECHNICAL FIELD

The present disclosure relates to a photodetection element and an electronic device.

### BACKGROUND ART

In a conventional device including an event detection pixel, in the light receiving area, low consumption control such as power consumption control and clock control is operated according to settings of a predetermined window regardless of the imaging scene. Thus, normal driving may be performed even for an area where no event has occurred and low consumption control is to be performed, and power may be wastefully consumed.

For example, in a field other than event detection, processing of changing the mode for low consumption control is implemented after event detection is performed in units of frames, which leads to a situation where low power consumption starts from the next frame at the earliest. Moreover, in the low power consumption mode, a pixel addition mode is set and the resolution is reduced, and thus there is a trade-off between the low power consumption and the resolution. In addition, there is also a technology of setting an analog to digital converter (ADC) outside a set region to a standby state, but in this technology, the ADC is set to the standby state according to settings regardless of the imaging scene, and thus there is also a trade-off between the power and the resolution.

### CITATION LIST

### Patent Document

Patent Document 1: Japanese Patent Application Laid-Open No. 2018-022935 A

### SUMMARY OF THE INVENTION

### Problems to be Solved by the Invention

Therefore, the present disclosure provides a photodetection element that achieves low power consumption without reducing resolution in event detection.

### Solutions to Problems

According to an embodiment, the photodetection element includes a pixel array, a holding circuit, a control circuit, and a signal processing circuit. In the pixel array, event detection elements that detect an intensity difference of received light are arranged in a two-dimensional array. The holding circuit holds an event detected by the event detection elements. The control circuit controls a power supply voltage and a clock signal for the event detection element belonging to at least a partial region of the pixel array and the holding circuit corresponding to the event detection element. The signal processing circuit processes a signal output from the event detection element.

The pixel array may include the event detection elements arranged in a two-dimensional array continuous in a line direction and a column direction intersecting the line direction, the holding circuit may hold the event for each of lines in the pixel array, and the control circuit may select the event detection pixels that are continuous in the line direction in the pixel array and drive the event detection elements belonging to the selected line, and control the power supply voltage and the clock signal of the event detection elements for each of the lines on the basis of the event held for each of the lines.

The control circuit may control, for each of the lines, a bias voltage related to the event detection elements, and the power supply voltage and the clock signal of the signal processing circuit related to the event detection elements.

The control circuit may control the power supply voltage of the event detection elements on the basis of the event output for each of one or a plurality of lines.

The control circuit may divide the event detection elements belonging to the one or the plurality of lines into a plurality of groups, and controls the event detection elements for each of the groups.

The control circuit may control the power supply voltage of the event detection elements on the basis of the event output for each of one or a plurality of columns.

The control circuit may divide the event detection elements belonging to the one or the plurality of columns into a plurality of groups, and controls the event detection elements for each of the groups.

The control circuit may control the power supply voltage for each of the event detection pixels.

The control circuit may control the power supply voltage on the basis of the event information in a past frame.

The pixel array may further include a gradation information acquisition element that acquires gradation information.

The pixel array may further include an element that acquires time of flight (ToF) information.

The control circuit may perform standby control on a line in which the event has not occurred.

The control circuit may switch a drive mode on the basis of a firing rate of the event of the event detection elements.

The control circuit may switch processing of a column analog to digital converter (ADC) on the basis of an occurrence state of the event in a line to be read. The control circuit may read the event from a line on which the event has occurred.

The event detection elements may share an analog front end.

The event detection elements may share a difference circuit and a comparison circuit.

The event detection elements may share a comparison circuit.

The event detection elements may share a circuit connected to the power supply voltage.

The control circuit may execute clock control of a peripheral circuit on the basis of a signal related to the event detected by the event detection elements.

The control circuit may switch a clock frequency of the peripheral circuit on the basis of a signal related to the event.

According to an embodiment, an electronic device includes the photodetection element according to any one of the above, a signal processing circuit, and an external processing circuit. The signal processing circuit executes signal processing based on a signal related to the event output from the photodetection element. The external processing circuit executes arbitrary processing on the basis of a signal output from the signal processing circuit.

According to an embodiment, the electronic device described above may be an in-vehicle device.

### BRIEF DESCRIPTION OF DRAWINGS

FIG. 1 is a block diagram schematically illustrating a photodetection element according to an embodiment.

FIG. 2 is a diagram illustrating an example of connection between a control circuit and a pixel according to the embodiment.

FIG. 3 is a diagram illustrating an example of a pixel according to the embodiment.

FIG. 4 is a diagram illustrating an example of a part of an access control circuit according to the embodiment.

FIG. 5 is a flowchart illustrating an example of processing in the photodetection element according to the embodiment.

FIG. 6 is a diagram illustrating an example of a timing chart of the photodetection element according to the embodiment.

FIG. 7 is a diagram illustrating an example of a relationship between processing in a line and time according to the embodiment.

FIG. 8 is a block diagram schematically illustrating a photodetection element according to an embodiment.

FIG. 9 is a flowchart illustrating an example of processing of the photodetection element according to the embodiment.

FIG. 10 is a diagram illustrating an example of a pixel circuit according to the embodiment.

FIG. 11 is a circuit diagram illustrating an example of a pixel circuit according to an embodiment.

FIG. 12 is a diagram illustrating an example of a relationship between processing in a line and time according to the embodiment.

FIG. 13 is a circuit diagram illustrating an example of a pixel circuit according to an embodiment.

FIG. 14 is a diagram illustrating an example of a timing chart of a photodetection element according to the embodiment.

FIG. 15 is a diagram illustrating an example of connection between a control circuit and pixels according to an embodiment.

FIG. 16 is a diagram illustrating an example of a pixel circuit according to the embodiment.

FIG. 17 is a diagram illustrating an example of connection between the control circuit and the pixels according to the embodiment.

FIG. 18 is a diagram illustrating an example of the pixel circuit according to the embodiment.

FIG. 19 is a diagram illustrating an example of connection between a control circuit and pixels according to an embodiment.

FIG. 20 is a diagram illustrating an example of connection between a control circuit and pixels according to an embodiment.

FIG. 21 is a diagram illustrating an example of a pixel circuit according to an embodiment.

FIG. 22 is a diagram illustrating an example of a control circuit according to an embodiment.

FIG. 23 is a flowchart illustrating an example of processing of a photodetection element according to the embodiment.

FIG. 24 is a diagram illustrating an example of a peripheral circuit of a pixel array according to an embodiment.

FIG. 25 is a flowchart illustrating an example of processing of a photodetection element according to the embodiment.

FIG. 26 is a diagram illustrating an example of a pixel block according to an embodiment.

FIG. 27 is a diagram illustrating an example of circuit sharing in pixels according to the embodiment.

FIG. 28 is a diagram illustrating an example of circuit sharing in pixels according to the embodiment.

FIG. 29 is a diagram illustrating an example of a pixel block according to an embodiment.

FIG. 30 is a diagram illustrating an example of a pixel according to the embodiment.

FIG. 31 is a diagram illustrating an example of a pixel block according to the embodiment.

FIG. 32 is a diagram illustrating an example of a pixel array according to the embodiment.

FIG. 33 is a block diagram schematically illustrating a photodetection element according to an embodiment.

FIG. 34 is a diagram illustrating an example of mode transition of the photodetection element according to the embodiment.

FIG. 35 is a diagram illustrating an example of mode transition of the photodetection element according to the embodiment.

FIG. 36 is a block diagram schematically illustrating a photodetection element according to an embodiment.

FIG. 37 is a diagram illustrating an example of a relationship between a line and time according to the embodiment.

FIG. 38 is a diagram illustrating an example of a relationship between a line and time according to the embodiment.

FIG. 39 is a block diagram illustrating an example of a schematic configuration of a vehicle control system.

FIG. 40 is an explanatory diagram illustrating an example of installation positions of an outside-vehicle information detecting section and imaging sections.

### MODE FOR CARRYING OUT THE INVENTION

The following is a description of an embodiment of the present disclosure, with reference to the drawings. The drawings are used for description, and the shape and size of the configuration of each unit in the actual device, the ratio of the size to other configurations, and the like are not necessarily as illustrated in the drawings. Furthermore, since the drawings are illustrated in a simplified manner, configurations necessary for implementation other than those illustrated in the drawings are appropriately provided.

### First Embodiment

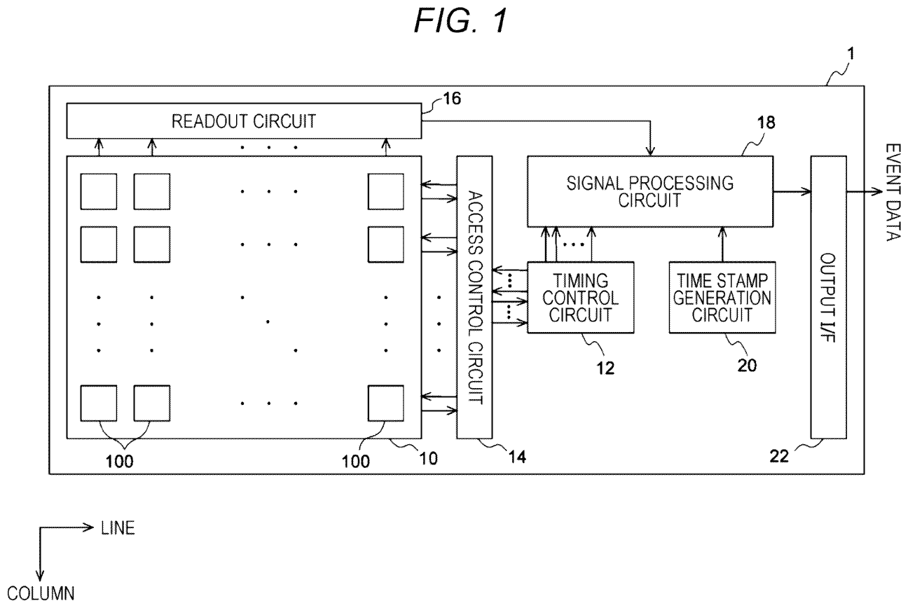

FIG. 1 is a block diagram schematically illustrating a non-limiting example of the photodetection element 1 according to the first embodiment. The photodetection element 1 includes a pixel array 10, a timing control circuit 12, an access control circuit 14, a first readout circuit 16, a first signal processing circuit 18, a time stamp generation circuit 20, and an output interface (hereinafter, it is described as an output I/F 22). The photodetection element 1 is a device that outputs information (event data) of a detected event at high speed and with low power consumption. As a non-limiting example, the photodetection element 1 may be provided in an electronic device such as an in-vehicle imaging device.

The pixel array 10 includes a plurality of pixels 100. The pixels 100 are arranged in at least a plurality of columns (line direction). Desirably, they are also arranged in at least a plurality of lines (in the column direction), and arranged in a two-dimensional array. The pixel array 10 includes a path for outputting a signal output from the pixel 100 to the readout circuit 16, a path for receiving a signal indicating which pixel 100 information is read from the access control circuit 14 that an event has been detected in a case where the event has been detected in the pixel 100, and a path for receiving a signal for reducing power consumption (a signal for lowering a power supply voltage) for the pixel 100. Hereinafter, unless otherwise required, the pixel 100 represents an event detection pixel.

Each pixel 100 includes an imaging element (event detection element) capable of at least event detection (detection). Each pixel 100 includes a pixel circuit that drives a detection element and appropriately acquires an output from the detection element. For example, the pixel circuit may be a circuit that compares a predetermined threshold value with a value related to an analog signal acquired by the event detection element to detect and output an event. As an example, the pixel 100 may be fired in a case where the difference from the previous frame exceeds a predetermined value, or as another example, may be fired in a case where the contrast ratio exceeds a predetermined threshold value. Here, firing indicates a state in which an event is detected in the pixel 100.

The timing control circuit 12 and the access control circuit 14 constitute a control circuit that controls access to the pixels 100, readout of signals from the pixels 100, timing of processing the read signals, and reduction in power consumption in the pixels 100. Hereinafter, the timing control circuit 12 and the access control circuit 14 may be collectively referred to as a control circuit, and some or all operations of these circuits may operate as a control circuit. The control circuit may control an output timing of a signal subjected to the signal processing. The control of the power consumption reduction may include, for example, at least one of control of a power supply voltage or control of a clock signal.

The pixel array 10 or the control circuit may include, for each line of the pixel array 10, a holding circuit that holds that an event has been detected in at least some pixels 100 of the plurality of pixels 100 belonging to the line. In this case, the power consumption reduction control may be configured to control a power supply voltage and a clock voltage of the holding circuit.

For example, the timing control circuit 12 outputs a frame synchronization signal and a horizontal synchronization signal to the access control circuit 14 on the basis of an input clock signal. In addition, the timing control circuit 12 may generate a timing to execute signal processing on the basis of the signal corresponding to a firing status of the pixel 100 received from the access control circuit 14, and output the timing to the signal processing circuit 18.

The access control circuit 14 outputs an operation signal for selecting the pixel 100 to be accessed on the basis of the horizontal direction synchronization signal acquired from the timing control circuit 12, and performs control to output event information from the pixel 100 to the readout circuit 16. That is, event detection in the present disclosure can be implemented by scanning the pixels 100 for each frame on the basis of the frame information output from the timing control circuit 12.

The readout circuit 16 appropriately converts information acquired from each pixel 100 and outputs the information to the signal processing circuit 18. The readout circuit 16 may include, for example, a circuit that operates as an analog front end (AFE). Note that the AEF may be provided not in the readout circuit 16 but in the pixel circuit of the pixel 100 that controls output from an event light receiving element provided in a preceding stage of the readout circuit 16.

The readout circuit 16 may include, for example, a latch that temporarily stores the event information output from each pixel 100 for each column. In addition, an analog to digital converter (ADC) that appropriately amplifies and analog-to-digital (AD) converts an analog signal output from the pixel 100 and outputs the analog signal may be included. The ADC may be, for example, an ADC provided for each pixel or an ADC provided for each column. The readout circuit 16 outputs appropriately converted event information as a serial or parallel signal.

The signal processing circuit 18 converts the event information output from the readout circuit 16 on the basis of access information of the pixel 100 controlled by the access control circuit 14 acquired via the timing control circuit 12, and outputs the event information as event data to the outside, for example, a processor provided outside, or the like via the output I/F 22. For example, the signal processing circuit 18 rearranges the order of the acquired event information or arranges the format thereof, and outputs the event information. In addition, as described above, the signal processing circuit 18 may execute signal processing at the synchronization timing generated by the timing control circuit 12 on the basis of the output of the access control circuit 14.

The time stamp generation circuit 20 outputs time stamp information, for example, simply time information, to the signal processing circuit 18. The signal processing circuit 18 gives an appropriate time stamp to the data and outputs the data. By appropriately providing the time stamp in this manner, it is possible to appropriately acquire the order related to the time of the output data by an external processor or the like and execute the signal processing.

The output I/F 22 is an interface that outputs the event data acquired and converted in the photodetection element 1 to the outside. The output I/F 22 may include, for example, an interface such as MIPI (registered trademark). The photodetection element 1 outputs the acquired event information to the outside via the output I/F 22.

By using such a configuration, it is possible to appropriately control a static period in a horizontal direction and a timing of the synchronization signal in the horizontal direction in accordance with the amount of data to be acquired.

In this configuration, the same synchronization signal can be used for synchronization signals of access control of the pixel array 10 (read control in the readout circuit 16) and signal processing control in the signal processing circuit 18. Thus, in the photodetection element 1, in a case where the data output speed is limited by a data bus, it is possible to implement high speed.

Note that the timing control circuit 12 is not a necessary component. For example, in a case where any one of the timing of accessing and reading of the pixel 100 and the timing of data transfer from the readout circuit 16 to the signal processing circuit 18 is not made variable, the synchronization signal can be fixed, so that the operation of the photodetection element 1 can be implemented without including the timing control circuit 12.

In addition, although not illustrated, the signal processing circuit 18 may include a frame memory. The frame memory is a memory area that stores information of a frame, and includes, for example, a memory circuit. The signal processing circuit 18 may store the event information for one frame acquired from the readout circuit 16 in the frame memory. Then, the signal processing circuit 18 can convert the event information into a format in which data transfer can be executed at high speed using the data stored in the frame memory and output the converted event information.

By providing the frame memory, timings of access control of the pixel array 10 and control of processing in the signal processing circuit 18 can be separated for each scanning line. That is, while the access of the pixel array 10 is controlled according to the synchronization signal of the predetermined period, regardless of this control, the processing in the signal processing circuit 18 can be performed using a variable synchronization signal, and a clock signal of the pixel circuit in the pixel 100 and a clock signal used for the processing in the signal processing circuit 18 can be configured separately. Thus, in a case where the output of the photodetection element 1 is rate-limited to the access to the pixel 100, it is possible to implement the high speed.

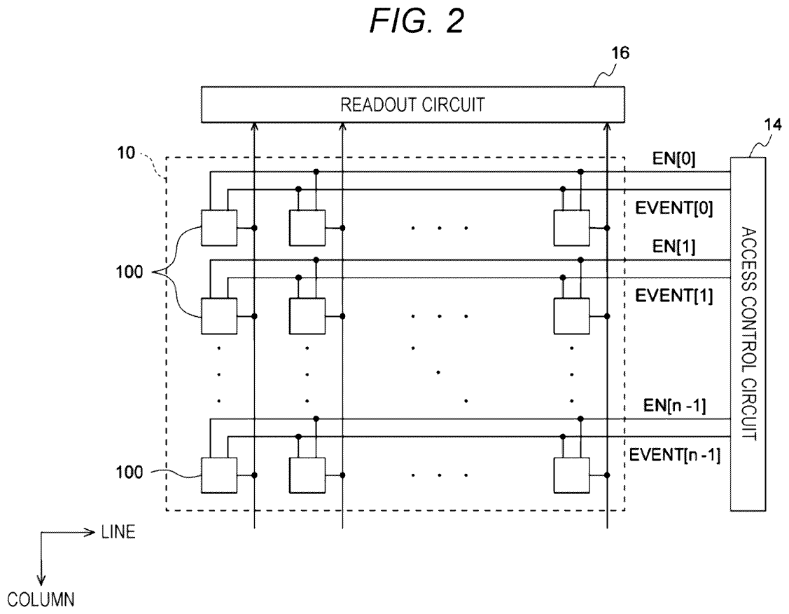

FIG. 2 is a diagram illustrating an example of connection between a control circuit and pixels according to an embodiment.

The holding circuit described above may hold an event detected for each line in the pixel array 10. Then, the control circuit selects a line in the pixel array 10 and drives the pixels 100 belonging to the selected line. This drive may be a circuit that operates similarly to a general horizontal drive circuit, and thus detailed description thereof will be omitted. Then, the control circuit may control the power supply voltage and the clock signal of the event detection element for each line on the basis of the event held for each line.

In order to implement such an operation, the photodetection element 1 includes a signal line that transmits an enable signal from the access control circuit 14 to the pixels 100 belonging to each line of the pixel array 10. Furthermore, the photodetection element 1 includes a signal line that transmits an event signal from the pixel 100 belonging to the line of the pixel array 10 to the access control circuit 14.

For example, the access control circuit 14 transmits and receives an enable signal EN[0] and an event signal EVENT[0] through different paths for the pixel 100 belonging to the 0-th line, and transmits and receives an enable signal EN and an event signal EVENT through different paths for the other lines. For example, in a case where there are n lines, an enable signal EN[n-1] and an event signal EVENT[n-1] are transmitted and received for each line.

By providing these signal lines, the access control circuit 14 can control a bias voltage in the pixel circuit related to the pixel 100 by the enable signal for each line. Furthermore, by acquiring the event signal for each line, the access control circuit 14 can also control the power supply voltage and the clock signal at the timing of performing processing of the line based on the event signal with respect to the signal processing circuit 18. This control may be implemented via the timing control circuit 12.

For example, in a line in which no event is detected, the access control circuit 14 can lower the bias voltage of the pixel circuit, lower the power supply voltage at the timing of processing the line in the signal processing circuit 18, lower the clock frequency, or stop the line.

In addition, event signals may be transmitted from the pixels 100 belonging to the same column to the readout circuit 16 via the same signal line. This mode is also similar in operation to a general vertical drive circuit, and thus detailed description thereof will be omitted.

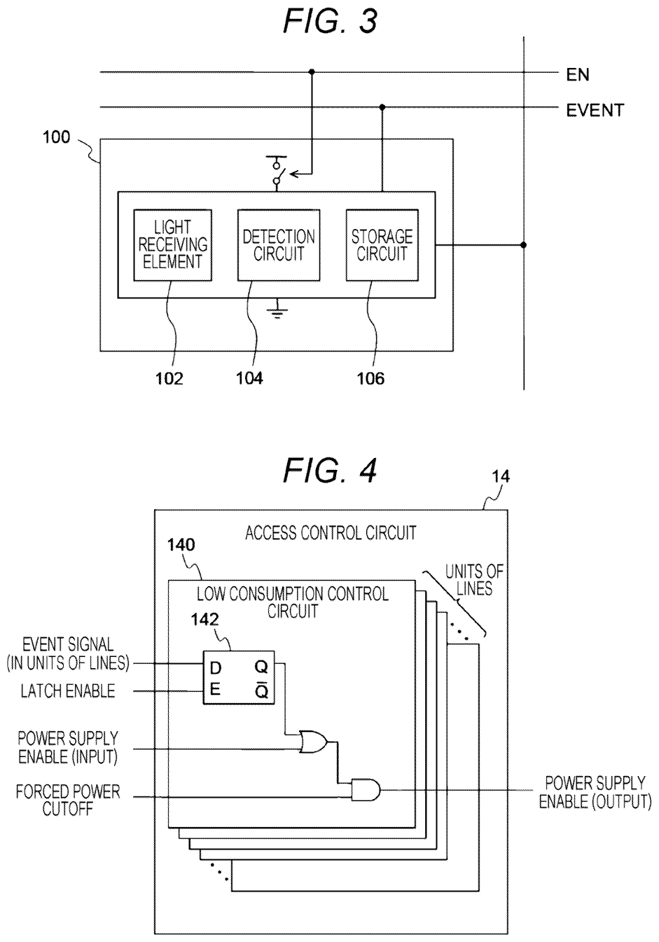

FIG. 3 is a diagram illustrating an example of the pixel 100. The pixel 100 may include a light receiving element 102, a detection circuit 104 as a pixel circuit thereof, and a storage circuit 106.

The light receiving element 102 includes, for example, a photoelectric conversion element that photoelectrically converts incident light, and a circuit that detects and outputs an event from a signal of the photoelectric conversion element.

The detection circuit 104 is, for example, a circuit that appropriately processes and outputs a signal output from the light receiving element 102 such as a buffer, a difference circuit, and a comparison circuit.

The storage circuit 106 may include, for example, a latch, a register, and the like, and may operate as a holding circuit that holds that an event has been detected.

The above three circuits may be circuits equivalent to general circuits that implement event detection, and thus detailed description thereof is omitted.

The enable signal from the access control circuit 14 is used, for example, as a signal for switching on/off of a switch element for switching connection between a power supply voltage in the pixel 100 and the pixel circuit. In a case where the switch element is turned on, the power supply voltage is applied to the above-described circuit, and event detection is executed. In a case where the switch element is off, the above-described circuit is disconnected from the power supply voltage and transitions to a standby state in which no event detection is performed.

FIG. 4 is a diagram illustrating an example of a part of the circuit of the access control circuit 14 for the pixel 100 in FIG. 3. The access control circuit may include a low consumption control circuit 140 as a part thereof. The low consumption control circuit 140 is a circuit that outputs an enable signal for executing switching in FIG. 3 on the basis of the event detection signal for each line acquired from the pixel 100. The low consumption control circuit 140 is provided, for example, in units of lines.

The low consumption control circuit 140 includes, for example, an event holding unit 142, an OR circuit, and an AND circuit. In a case where an event is detected in at least one of the pixels 100 belonging to the line, the low consumption control circuit 140 connects the power supply voltage and the pixel 100 belonging to the line at the next scanning timing such as the next frame, and outputs a signal for controlling disconnection between the pixel circuit of the pixel 100 and the power supply voltage in a case where no event is detected.

The event holding unit 142 may be, for example, a latch circuit. In addition, it may be configured by a circuit such as a flip-flop that implements an appropriate operation. The event detection signal from the pixel 100 belonging to the corresponding line in the pixel array 10 and a latch signal (latch enable) are input to the event holding unit 142. This event detection signal is held. When the latch signal is input, the event holding unit 142 outputs the held event signal. Note that, in the drawing, there is a negative output terminal of the held signal, but this is not a necessary configuration, and it is sufficient if there is an output terminal of the held signal.

The signal output from the event holding unit 142 is input to the OR circuit together with a power supply enable signal. The power supply enable signal may be output from the timing control circuit 12, for example. The OR circuit outputs a High signal when an event related to the line is detected or when a signal with which power is supplied is in an input state, and outputs a Low signal when no event is detected and power supply is necessary.

The AND circuit receives an output from the OR circuit and a forced power cutoff signal for forced power cutoff control. When the forced power cutoff is Low, that is, when a signal for forcibly cutting off the power is input, the AND circuit outputs Low which is a signal for cutting off the power supply as the power supply enable signal. On the other hand, when High which is a signal for not performing requested power cutoff is input, the AND circuit outputs a power supply enable signal corresponding to the output from the OR circuit.

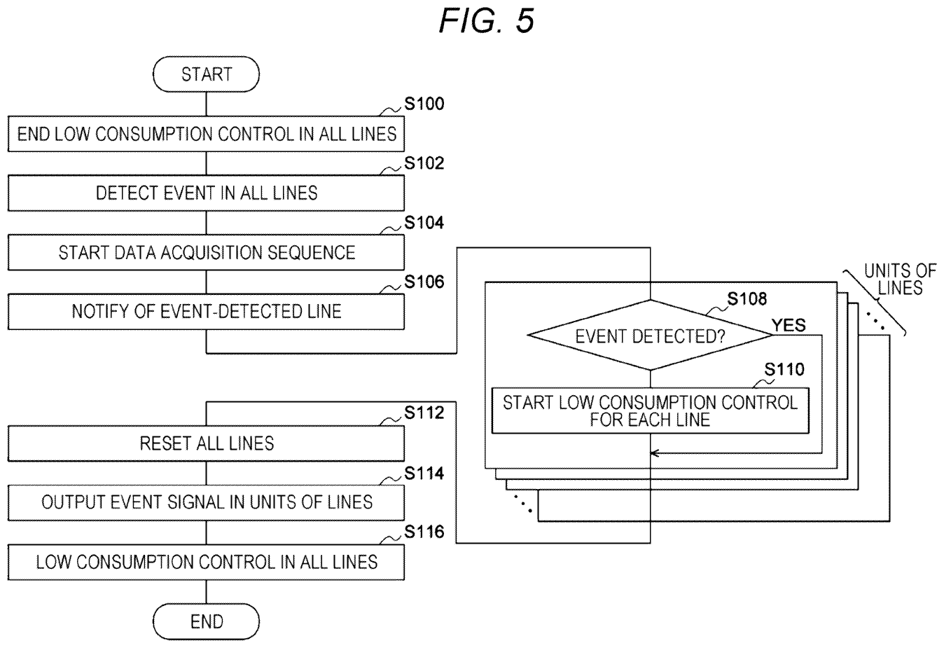

FIG. 5 is a flowchart illustrating processing in a case where the circuits of FIGS. 1 to 4 are used. Hereinafter, control related to low power consumption such as stop or suppression of application of a power supply voltage, or stop of a clock signal or processing of reducing a clock frequency will be referred to as low consumption control.

The control circuit ends the low consumption control in all the lines (S100). By ending the low consumption control, the state transitions to a state in which event detection processing can be performed in the pixels 100 belonging to the pixel array 10.

Next, the control circuit performs event detection in all lines (S102). The pixel 100 detects a luminance change of the incident light, and generates and outputs an event detection signal on the basis of the detected result.

Next, the control circuit starts a data acquisition sequence (S104). Since the event information is detected in the pixel 100 belonging to the pixel array 10 in S102, the detection state of the event for each line is held in the event holding unit by transmitting a signal indicating that the event information has been acquired from the pixel 100.

Next, the pixel 100 notifies the control circuit of the line in which the event is detected via the signal line provided for each line (S106). This is implemented by transmitting the EVENT signal illustrated in FIGS. 2 and 3 to the control circuit.

Next, the control circuit determines the event signal detection for each line in the low consumption control circuit 140 illustrated in FIG. 4 (S108). The low consumption control circuit 140 determines whether or not an event has been detected in the corresponding line on the basis of the event signal notified from the pixel 100 for each line.

In a case where no event is detected (S108: NO), the control circuit (low consumption control circuit 140) starts the low consumption control of the corresponding line (S110). For example, the control circuit executes the low consumption control by turning off a switch with the power supply voltage illustrated in FIG. 3 for the pixel 100 belonging to the line.

After the low consumption control ends, or in a case where an event is detected in the line (S108: YES), the low consumption control circuit 140 completes the processing and waits until processing for the next frame.

Next, the control circuit resets the charge of the event detection element for the pixel 100 belonging to the pixel array 10 (S112).

Then, the pixel 100 sequentially outputs the event detection signal in the column controlled by the control circuit to the readout circuit 16, and the readout circuit 16 outputs the event signal for each pixel 100 in units of lines (S114).

The control circuit disconnects the supply of the power supply voltage to the pixel 100 at a timing after the output from the pixel 100 is completed, and transitions to a blank period for event detection in the next frame (S116). Thereafter, the photodetection element 1 repeats the processing from S100 in the processing of the next frame.

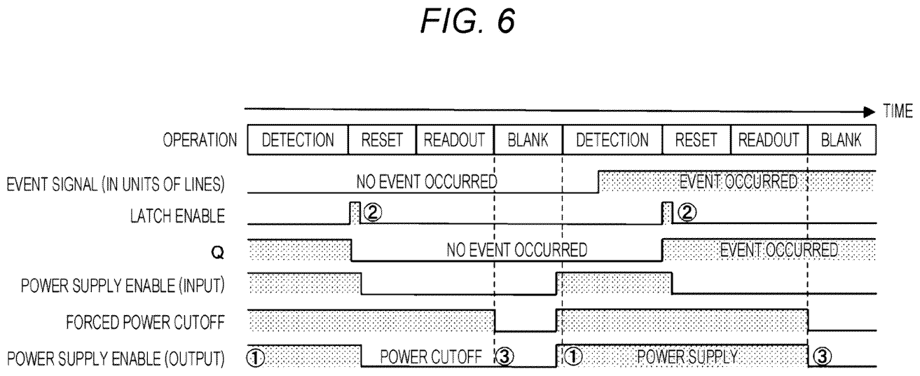

FIG. 6 is a diagram illustrating a timing chart in the processing. The circled number “1” corresponds to the processing timing of S100 in FIG. 5, “2” corresponds to the processing timing of S104, and “3” corresponds to the processing timing of S116.

In operation in the uppermost row, detection indicates an event detection timing in the pixel 100, reset indicates a reset timing of the light receiving element of the pixel 100, readout indicates a timing of transfer for each column in the line of the event detection signal from the pixel 100 and readout of the event detection signal for each line in the readout circuit 16, and blank indicates a waiting timing between frames.

Event signal (in units of lines) indicates an event detection signal for each line held in the event holding unit 142. When an event is detected, the event signal becomes High, and when no event is detected, the event signal becomes Low.

Latch enable indicates a latch signal input to the event holding unit 142. The latch enable becomes High at a timing when control to output data from the latch is performed.

Q indicates an event detection signal held and output in the event holding unit 142.

Power supply enable (input) is a signal input to the low consumption control circuit 140, and indicates a signal for controlling power supply to the pixel 100. The power supply enable (input) becomes High at a timing of performing control to supply power, and becomes Low at a timing of performing control not to supply power.

Forced power cutoff indicates, for example, a signal for controlling a timing of energization processing of the power supply voltage to the pixel 100 in the blank period or the like. The forced power cutoff becomes High at a timing of performing control not to cut off power, and becomes Low at a timing of performing control to cut off power.

Power supply enable (output) indicates a signal output from the low consumption control circuit 140, and a signal for controlling power supply to the pixel 100 based on an event detection result. The power supply enable (output) becomes High at a timing of performing control to supply power and becomes Low at a timing of performing control not to supply power.

At the start timing of the event detection processing in the frame, the power supply enable (input) and the forced power cutoff are High, and the power supply enable (output) is High from the circuit diagram of FIG. 4.

If an event signal in each line is undetected, the event signal for the line is Low, indicating that no event is detected.

In this state, when the latch enable is input, the event holding unit 142 outputs the held Low signal. Here, when the power supply enable (input) becomes Low at the end of the detection timing in the pixel 100, the output from the OR circuit of the low consumption control circuit 140 transitions to Low.

With this transition, the output from the AND circuit also transitions to Low, and the low consumption control circuit 140 outputs a signal Low for performing the low consumption control to the pixels 100 of the line corresponding to the low consumption control circuit 140 as the power supply enable (output). The low consumption control may be, for example, cutting off the power supply voltage and the pixel circuit as described above.

By this operation, in a case where the event detection signal is not output from the pixel 100 belonging to the line, the control circuit executes the low consumption control in the line.

In a case where an event signal in a line is detected, the event signal is High indicating event detection for each line.

When the latch signal transitions at a timing similar to the above, a High signal indicating that an event has occurred is output from the event holding unit 142. The OR circuit outputs High regardless of the power supply enable (input), and as a result, the low consumption control circuit 140 outputs a High signal for controlling power supply.

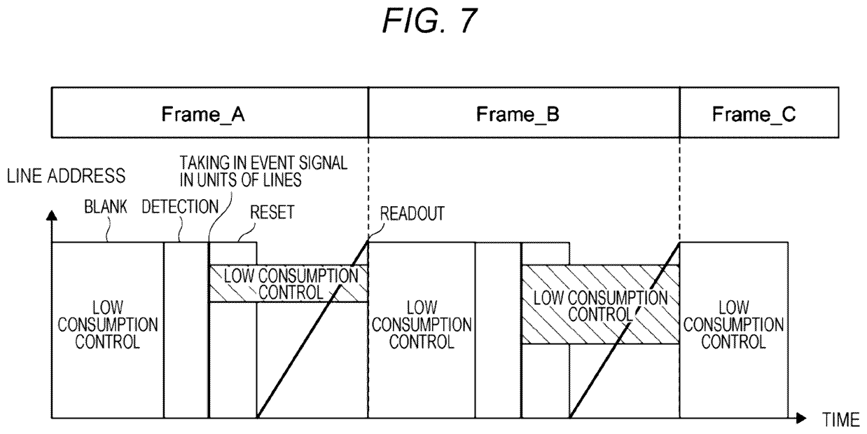

FIG. 7 is a diagram illustrating an example of a relationship between processing in a line and time in the above configuration.

In the blank period, the low consumption control is performed in all the lines, and the control circuit performs, for example, control to cut off the pixel circuit of the pixel 100 and the power supply voltage.

In a detection period, the control circuit performs control to connect the pixel circuit of the pixel 100 and the power supply voltage, and executes the event detection processing by acquiring the difference between the detection of light in the light receiving element and the frame of the detected light.

The control circuit acquires a result of event detection in the detection period for each line, and executes the low consumption control in a reset period and a readout period. A line indicated as low consumption control in the drawing is control applied to a line in which no event has been detected in the detection period.

As described above, with the photodetection element according to the present embodiment, the control circuit acquires an event detection result in the pixel belonging to the line, and performs the low consumption control for each line in a case where no event is detected, so that it is possible to implement high-speed low power consumption processing. As a result, it is possible to implement control of low power consumption of the entire photodetection element without lowering the resolution in event detection.

### Second Embodiment

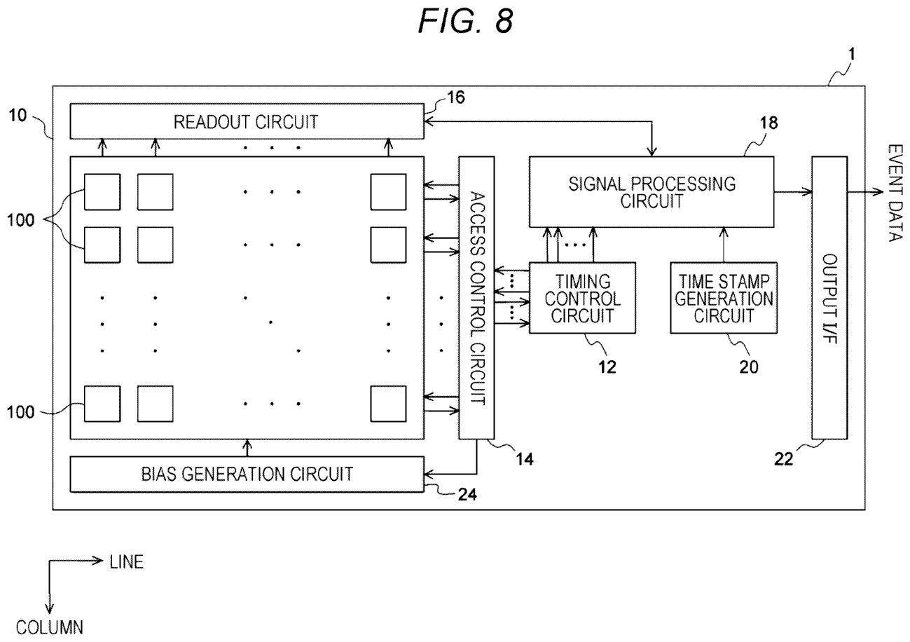

FIG. 8 is a block diagram schematically illustrating a photodetection element 1 according to an embodiment. The photodetection element 1 may include a bias generation circuit 24 in addition to the configuration of the first embodiment. Furthermore, a signal line for transmitting data from the signal processing circuit 18 to the readout circuit 16 may be provided.

The bias generation circuit 24 is a circuit that generates a bias current to be supplied to the pixel 100. The bias generation circuit 24 can control the magnitude of the bias current to be output to the pixel 100 by notification from the access control circuit 14.

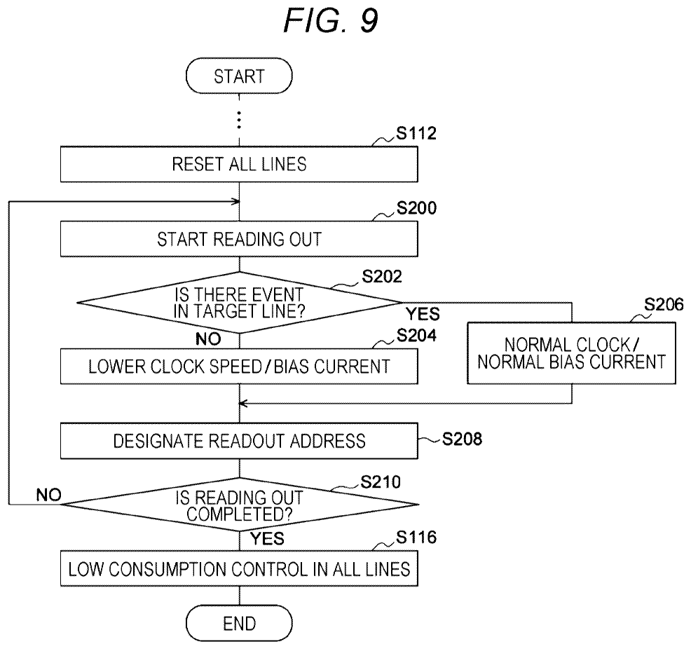

FIG. 9 is a flowchart illustrating processing of the photodetection element 1 according to the embodiment. The processing from S100 to S112 is similar to that of the first embodiment described above, and thus description thereof will be omitted.

After resetting the pixel 100 in S112, the readout circuit 16 starts reading out of an event (S200).

Next, the control circuit determines whether an event is detected in the target line (S202).

In a case where no event is detected (S202: NO), the control circuit may lower or stop the clock frequency of the clock signal output to the readout circuit 16 and the signal processing circuit 18 (S204), in addition to the operation of the low consumption control circuit 140 described above. Moreover, the control circuit performs control to reduce the bias current output from the bias generation circuit 24.

In a case where an event is detected (S202: YES), the control circuit performs control to cause a normal clock frequency and a normal bias current to flow to peripheral circuits such as the pixel 100, the readout circuit 16, and the signal processing circuit 18 (S206).

Then, the control circuit increments the readout address (S208).

In a case where the reading out is not completed (S210: NO), the control circuit returns to the processing of reading out of the event information of the address set in S208 (S200).

In a case where the reading out is completed (S210: YES), the control circuit shifts from the process of S116 to the process of the next frame as in the above-described embodiment.

As described above, according to the present embodiment, it is possible to further implement low consumption control as compared to the above-described embodiment.

### Third Embodiment

In each of the above-described embodiments, the low consumption control processing is collectively performed for the pixel circuits in the pixel 100 but is not limited thereto.

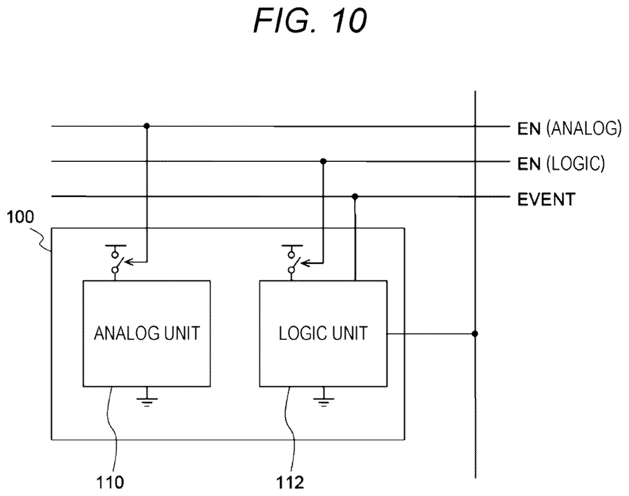

FIG. 10 is a diagram illustrating a pixel circuit of pixels 100 according to an embodiment. The pixel 100 may include an analog unit 110 and a logic unit 112 as a pixel circuit.

The analog unit 110 includes a light receiving element and is formed by an analog circuit that processes a signal output from the light receiving element. The analog unit 110 includes, for example, a light receiving element, a buffer, a difference circuit, and a comparison circuit.

The logic unit 112 is formed by a digital circuit that processes a digital signal in a case where the signal of the light receiving element is converted into the digital signal indicating a binary value indicating whether or not the event is detected in the analog unit 110. The logic unit 112 includes, for example, an output circuit. The comparison circuit may be provided in the logic unit 112 instead of the analog unit 110.

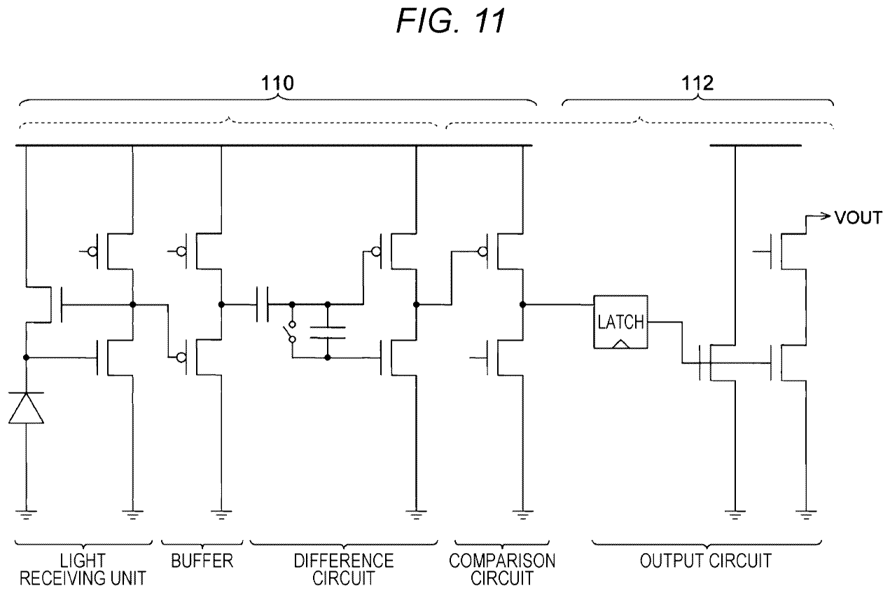

FIG. 11 is a circuit diagram illustrating a pixel circuit of the pixel 100 as an example of FIG. 10. As illustrated in this drawing, the analog unit 110 of the pixel circuit includes, for example, a light receiving unit including a light receiving element, a buffer that temporarily holds an output from the light receiving element, a difference circuit that outputs a difference between the output from the buffer and a value one frame before, and a comparison circuit that compares the output from the difference circuit with a threshold value.

Then, the logic unit 112 of the pixel circuit includes an output circuit including a latch circuit that latches an output result from a comparison circuit. As indicated by a dotted line, the comparison circuit may be configured as a part of the logic unit 112.

Returning to FIG. 10, the control circuit can also execute the low consumption control for each of the analog unit 110 and the logic unit 112. That is, the control circuit can individually execute power supply control of the analog front end that detects an event in the pixel circuit and power supply control of the logic circuit including the output circuit.

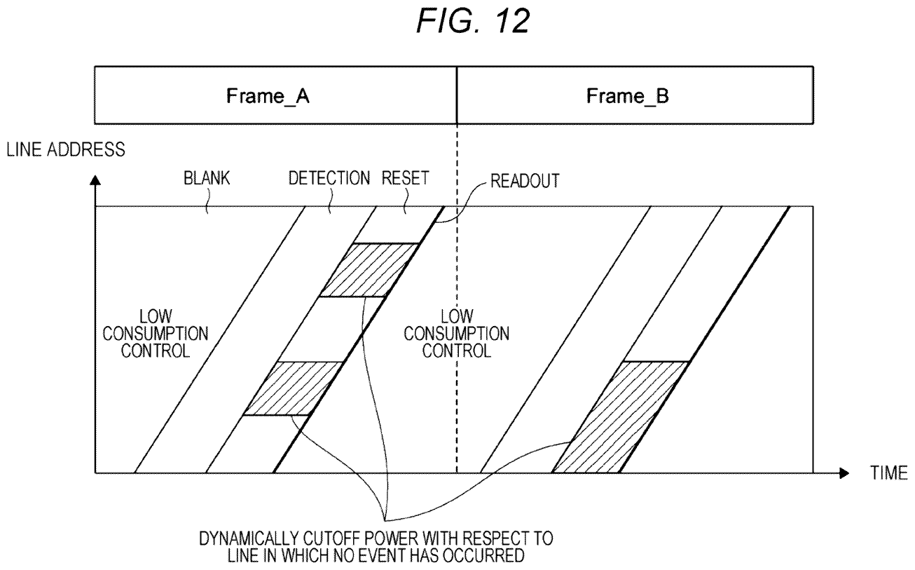

FIG. 12 is a diagram illustrating an example of a relationship between processing in a line and time according to the embodiment. As in the present embodiment, by separately implementing the power supply control for the analog circuit and the digital circuit in the pixel circuit, the control circuit can implement the low consumption control for each line in the reset period even in a case of executing the low consumption control sequentially from the line in which the output from the pixel circuit is completed.

### Fourth Embodiment

As described above, the access control circuit 14 holds a firing state (event detection state) for each line in the event holding unit 142. Thus, the bias in the pixel circuit of the pixel 100 can be controlled from the control circuit side.

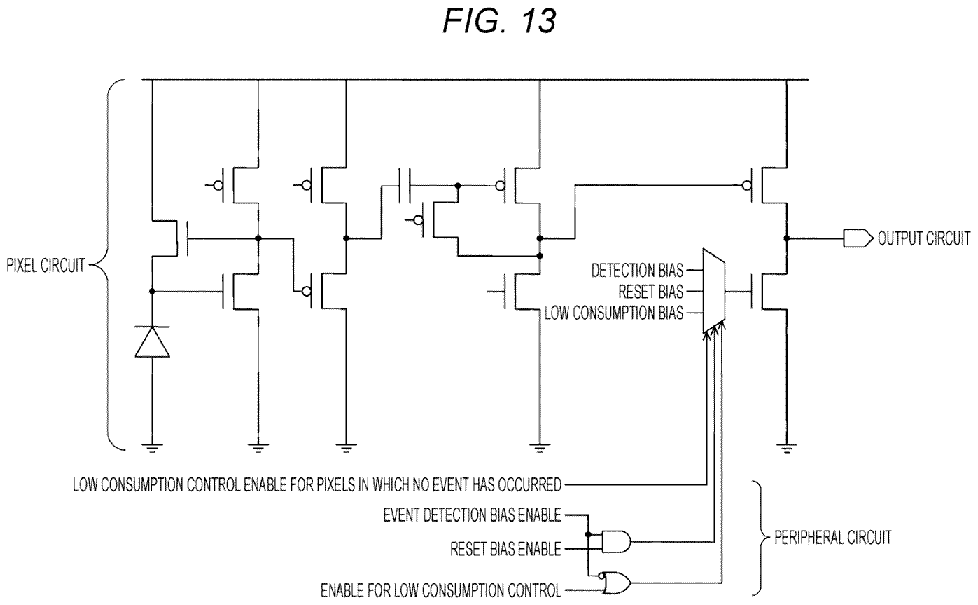

FIG. 13 is a diagram illustrating an example of a pixel circuit in a case where bias of the pixel circuit is controlled from the control circuit. The pixel circuit may be in a mode in which a detection bias, a reset bias, and a low consumption bias are selectively applied as the bias for determining the threshold value of the comparison circuit. The comparison circuit may include, for example, a selector (multiplexer) that selects one of these biases.

The detection bias is a bias applied during the event detection period. The reset bias is a bias applied during the reset period. The low consumption bias is a bias applied in a low consumption period. By selecting the bias in this manner, it is possible to output an appropriate comparison result in each period and execute the low consumption control.

This selector is formed to be able to select a bias on the basis of, for example, a low consumption control enable signal for pixels in which no event has occurred, an event detection bias enable signal, a reset bias enable signal, and a low consumption control enable signal.

The low consumption control enable signal for pixels in which no event has occurred is a signal that is

Low in a line in which an event has occurred and is High in a line in which no event has occurred. The other enable signals are signals in which High and Low are determined in order to control the bias to the respective states.

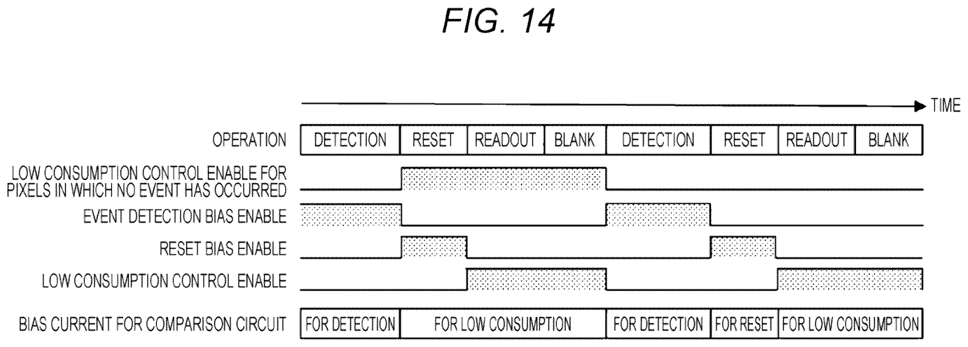

FIG. 14 is a diagram illustrating a timing chart of these enable signals. The low consumption bias is selected in a reset operation period at a timing when the low consumption control enable signal for pixels in which no event has occurred is High, and the reset bias is selected in the reset operation period at a timing when the low consumption control enable signal for pixels in which no event has occurred is Low.

As described above, according to the present embodiment, the low consumption control in the reset period can be implemented by using the enable signal and the appropriate bias current in each period.

### Fifth Embodiment

In each of the above-described embodiments, it has been described that the low consumption control is performed on the pixels 100 arranged in the line direction, but the photodetection element 1 in the present disclosure can similarly perform the low consumption control on the pixels 100 arranged in the column direction.

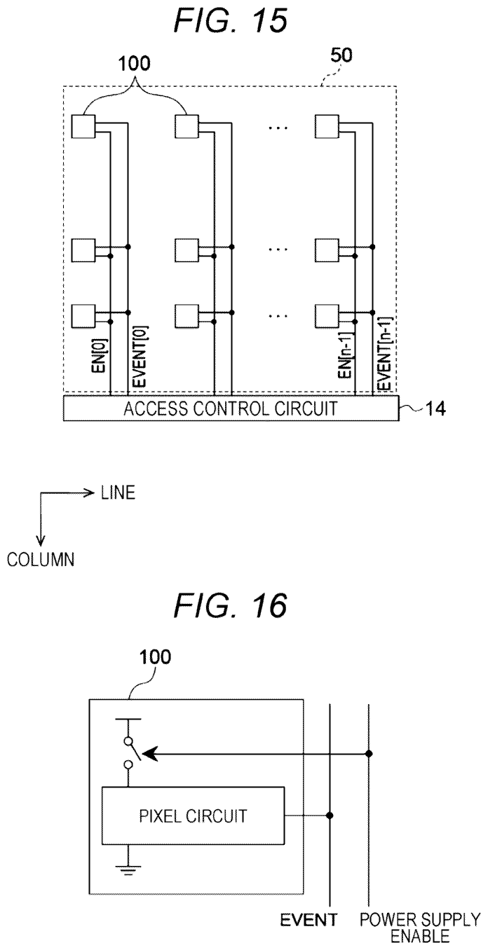

FIG. 15 is a diagram illustrating an example of connection between a control circuit and pixels according to an embodiment. The access control circuit 14 may include a signal line connected to the pixels 100 belonging to the same column in the column direction. Similarly to the first embodiment, these signal lines are a signal line that transmits an enable signal for performing the low consumption control in the pixel 100, and a signal line that transmits event detection information from the pixel 100 to the access control circuit 14.

That is, the access control circuit 14 transmits an enable signal for performing the low consumption control to the pixel 100 via the signal line for each column via the signal line. Furthermore, the pixel 100 transmits an event detection signal for transmitting an enable signal for performing the low consumption control in the column in the access control circuit 14 via the signal line.

FIG. 16 is a diagram illustrating an example of a pixel circuit according to the embodiment. Connection of the pixel circuit to the power supply voltage is controlled on the basis of power supply enable transmitted from the access control circuit 14. Furthermore, the event information output from the pixel circuit is transmitted to the access control circuit 14 via the signal line, and the access control circuit 14 determines whether or not an event has been detected for each column on the basis of the event information.

As described above, the photodetection element 1 can also perform the low consumption control for each column on the basis of event information from pixels continuous in the column direction, not in the line direction.

Note that these need not be separately mounted, and the photodetection element 1 may acquire event information for both the line direction and the column direction and perform the low consumption control for each line and each column.

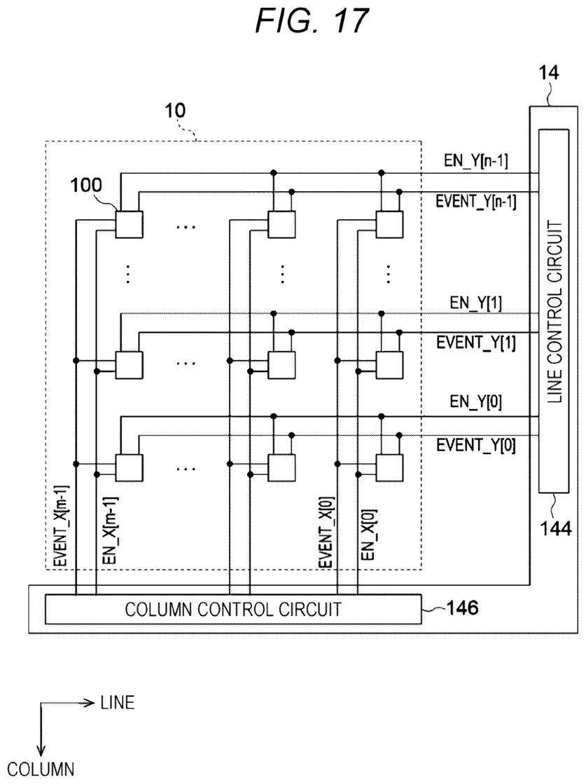

FIG. 17 is a diagram illustrating connection between control circuits that perform the low consumption control for both directions of a line and a column and a pixel. The access control circuit 14 may include a line control circuit 144 and a column control circuit 146. However, the access control circuit 14 may perform control without such distinction.

The line control circuit 144 may operate in the same manner as the access control circuit 14 illustrated in FIG. 2, and the column control circuit 146 may operate in the same manner as the access control circuit 14 illustrated in FIG. 15.

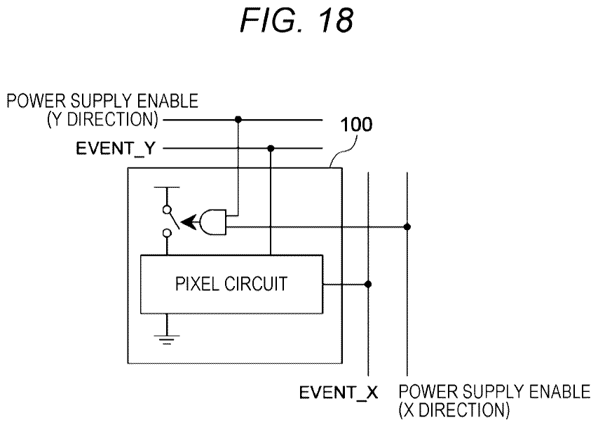

FIG. 18 illustrates a pixel circuit in the case of FIG. 17. As illustrated in the drawing, in the pixel circuit, the connection with the power supply voltage is controlled by a logical product of signals received from the power supply enable (Y direction) in the line direction output from the line control circuit 144 on the basis of the event information for each line and the power supply enable (X direction) in the column direction output from the column control circuit 146 on the basis of the event information for each column.

That is, in a case where both the event information in the line direction and the event information in the column direction are detected, the pixel 100 can be set as a normal detectable pixel, and the other pixels can be set as pixels for which the low consumption control is performed.

Furthermore, the pixel circuit outputs event information (EVENT_Y) to the line control circuit 144 via a signal line along the line, and outputs event information (EVENT_X) to the column control circuit 146 via a signal line along the column.

As described above, the control circuit and the pixel circuit can transmit and receive the event information and the enable signal via a signal line connecting the pixels belonging to the same line and a signal line connecting the pixels in the same column.

By performing the low consumption control in the line direction and the column direction, it is possible to perform the low consumption control with finer granularity, and to further reduce the power consumption.

### Sixth Embodiment

In each of the above-described embodiments, the example of performing the low consumption control for each line and each column has been described, but a group may be formed for each of a plurality of columns in the same line, and the low consumption control may be performed for each group.

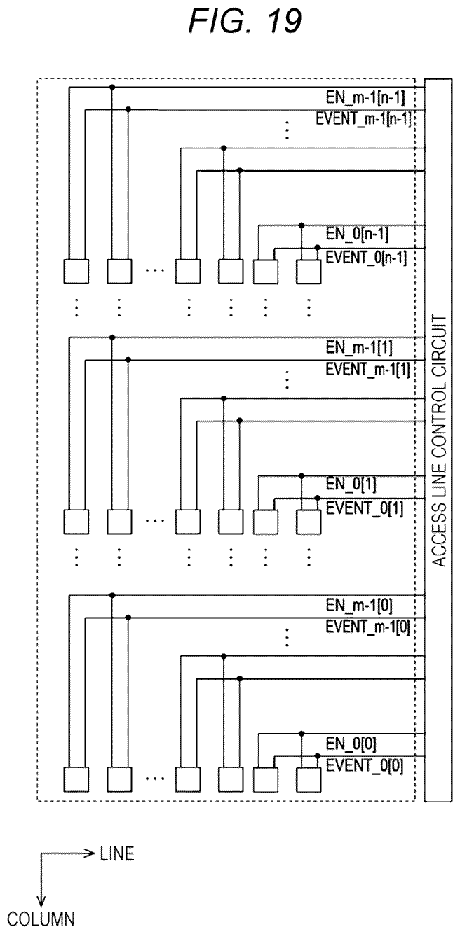

FIG. 19 is a diagram illustrating an example of connection between a control circuit and pixels according to an embodiment. For example, the access control circuit 14 may divide the pixels 100 belonging to the line into a plurality of pixel groups for each line and execute the low consumption control on each of the pixel groups. In the pixel 100, for example, as illustrated in FIG. 19, a pixel group may be formed for every two pixels 100 adjacent in the line direction.

The group may be formed in any manner, and non-adjacent pixels 100 may belong to the same group. In addition, a group may be formed not for every two pixels 100 but for every more pixels 100. In general, objects often fit within pixels that are in close proximity. Thus, it is more desirable to form a pixel group for each of the plurality of adjacent pixels 100.

As described above, the photodetection element 1 may be divided not only for each line but also into a plurality of groups belonging to the same line, and the low consumption control may be executed by each group.

Note that, in the present embodiment, the control circuit performs the low consumption control in the group belonging to each line, but the present embodiment is not limited thereto, and the low consumption control may be performed in each group belonging to each column.

### Seventh Embodiment

In each of the above-described embodiments, the control circuit performs the low consumption control for each line or each column, but the embodiments are not limited thereto. The control circuit can also perform the low consumption control for each of a plurality of lines or for each of a plurality of columns.

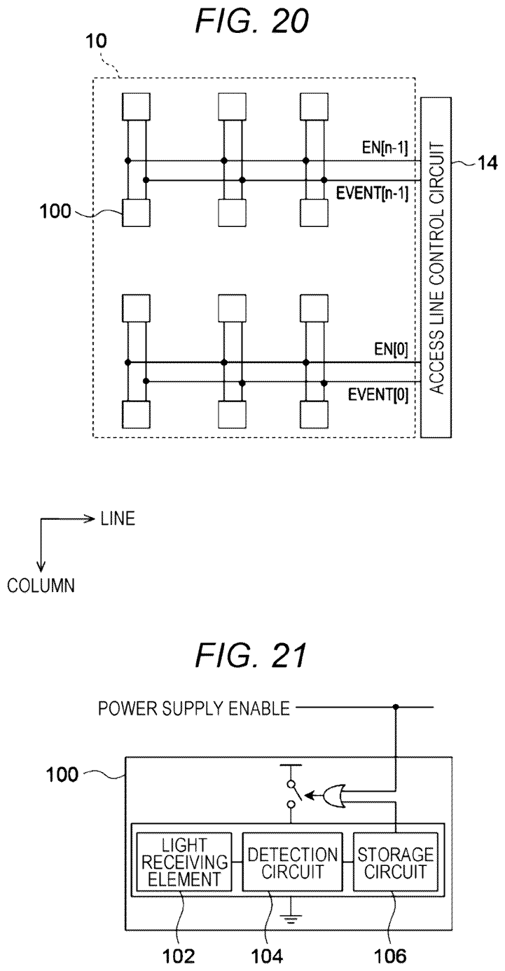

FIG. 20 is a diagram illustrating an example of connection between a control circuit and pixels according to an embodiment. As illustrated in FIG. 20, the access control circuit 14 and the pixels 100 belonging to two lines may be in a mode of being connected to a signal line that transmits the same event detection signal and a signal line that transmits the same enable signal.

In FIG. 20, the control is performed every two lines, but the present embodiment is not limited thereto, and a mode in which the low consumption control can be performed every three or more lines may be used.

### Eighth Embodiment

In each of the above-described embodiments, the signal line system for transmitting the event detection information from the pixels 100 to the control circuit and the signal line system for transmitting the enable signal from the control circuit to the pixels 100 are provided to perform the low consumption control, and the control is separately performed for each line or each column via these signal lines, but the present embodiment is not limited thereto.

FIG. 21 is a diagram illustrating an example of a pixel circuit according to an embodiment. A power supply enable signal is an enable signal for controlling whether or not to supply power corresponding to a period in a frame for each line or each column from the control circuit, for example. Specifically, the power supply enable signal is, for example, an enable signal for performing the low consumption control during a blank period and controlling a normal voltage or the like during a detection period.

The pixel 100 may control connection between the power supply voltage and the pixel circuit by the OR of the enable signal and an output from a latch circuit or the like holding event information such as a previous frame in the pixel circuit.

With such control, it is possible to execute the low consumption control according to finer granularity, for example, a past event detection state for each pixel.

### Ninth Embodiment

In performing the low consumption control for each line, the control circuit includes an event counter that counts the number of occurrences of an event for each line, and can perform the low consumption control by a count value.

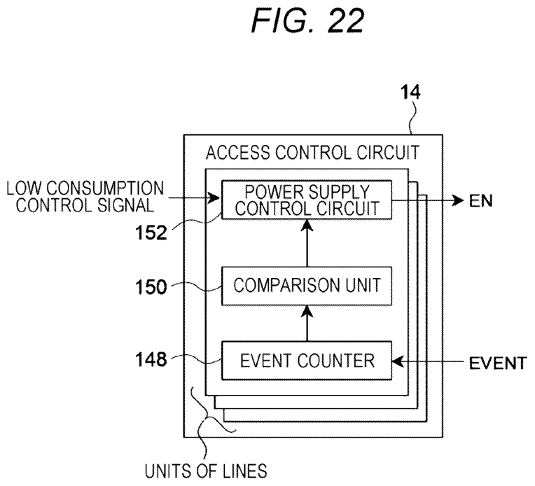

FIG. 22 is a diagram illustrating an example of a control circuit according to an embodiment. For example, the access control circuit 14 may include an event counter 148, a comparison unit 150, and a power supply control circuit 152. The event counter 148 is a counter that counts the number of events in the past frame. The event counter 148 is a counter that is initialized at a predetermined timing and is incremented when an event in the line is detected. The comparison unit 150 is a circuit that compares the count value of the event counter 148 with a predetermined value and outputs a comparison result.

The power supply control circuit 152 is a circuit that outputs an enable signal that is a control signal of the power supply on the basis of the output of the comparison unit 150.

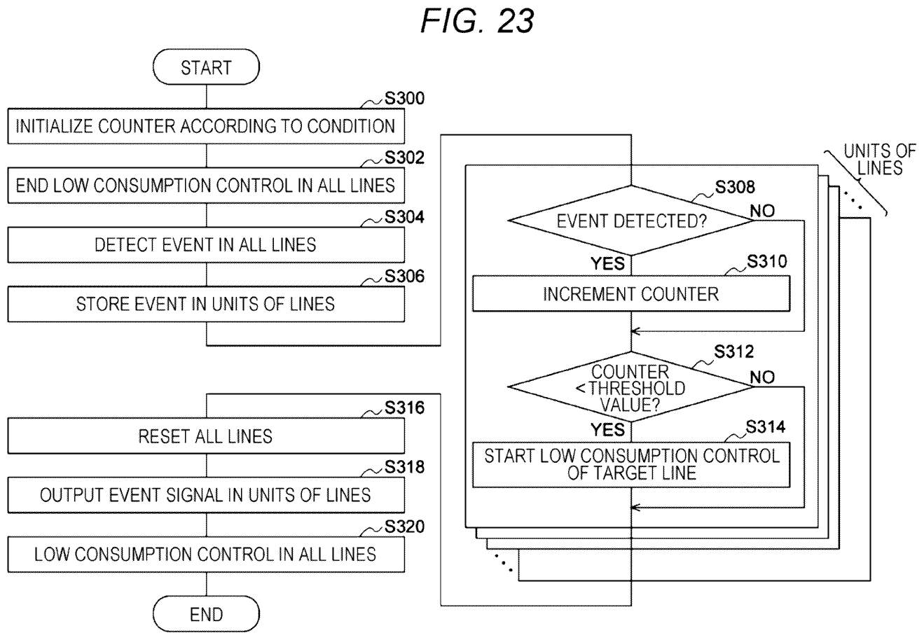

FIG. 23 is a flowchart illustrating an example of processing of the photodetection element 1 in the case of having the configuration of FIG. 22.

The control circuit initializes the counter according to a condition (S300). The condition may be, for example, immediately after the photodetection element 1 is activated or every predetermined number of frames.

The control circuit ends the low consumption control of all the lines, and transitions from the blank period to the detection period (S302).

The pixel 100 executes detection in a state in which the low consumption control is not performed in the detection period (S304).

The control circuit stores and holds events in units of lines on the basis of the event information output from the pixel 100 (S306).

The control circuit determines whether or not an event is detected for each line (S308).

In a case where an event is detected (S308: YES), the control circuit increments the count value using the event counter 148 (S310).

After the count value is incremented or in a case where no event is detected (S308: NO), the control circuit compares whether the count value is smaller than a threshold value in the comparison unit 150 (S312).

In a case where the count value is less than the threshold value (S312: YES), the control circuit starts the low consumption control of the target line (S314). On the other hand, in a case where the counted value is equal to or more than the threshold value (S312: NO), the control circuit continues normal control.

The subsequent processing (S316 to S320) is similar to that of the above-described embodiment.

In this manner, by counting the number of occurrences of an event over a plurality of past frames, it is possible to perform the low consumption control for each line depending on the frequency at which the event has occurred. Furthermore, the control circuit can similarly perform control by a count value for each column, each group, or each pixel described in the above-described embodiment.

Note that, in FIG. 23, the counter is initialized according to a condition, but the present embodiment is not limited thereto. For example, S300 may be omitted, and the control circuit may be in a mode of decrementing the count value in a case where no event is detected (S308: NO). In this case, after an event is detected in a plurality of frames, transition to the low consumption control can be performed on the basis of the event detection frequency from the last event detection frame.

### Tenth Embodiment

Although the mode in which event detection pixels are scanned to detect an event has been described, the photodetection element 1 of the present disclosure is not limited to this mode. Even in a case where the photodetection element 1 is controlled by the arbiter, similar low consumption control can be performed.

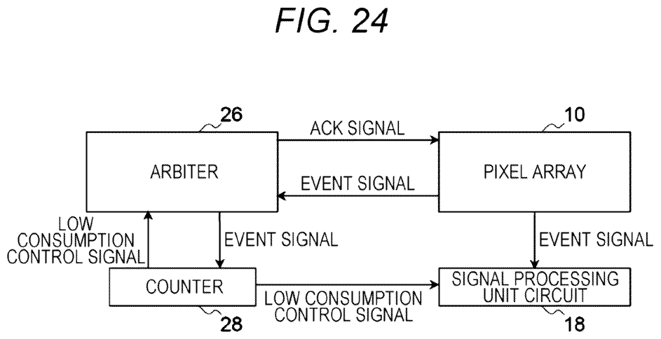

FIG. 24 is a diagram illustrating an example of a peripheral circuit of the pixel array 10 according to an embodiment. The pixel array 10 may be connected to the arbiter 26 and the signal processing circuit 18, and the arbiter 26 and the signal processing circuit 18 may be connected to the counter 28. The arbiter 26 and the counter 28 may be mounted as a part of the control circuit.

The arbiter 26 is an arbiter circuit that appropriately propagates event detection information not by control with a frame but asynchronously at a timing when the signal is output from the pixel 100. Upon receiving an event detection signal from the pixel 100, the arbiter 26 transmits an Ack signal to the pixel and transmits the event detection signal to the counter 28. The pixel 100 that has received the Ack may reset the light receiving element.

The counter 28 is a circuit that counts the number of occurrences of an event. Upon receiving the event detection signal, the counter 28 increments the count value to count the number of events currently being arbitrated. In a case where the count value is less than the predetermined value, the counter may output a low consumption control signal to the arbiter 26 and the signal processing circuit 18.

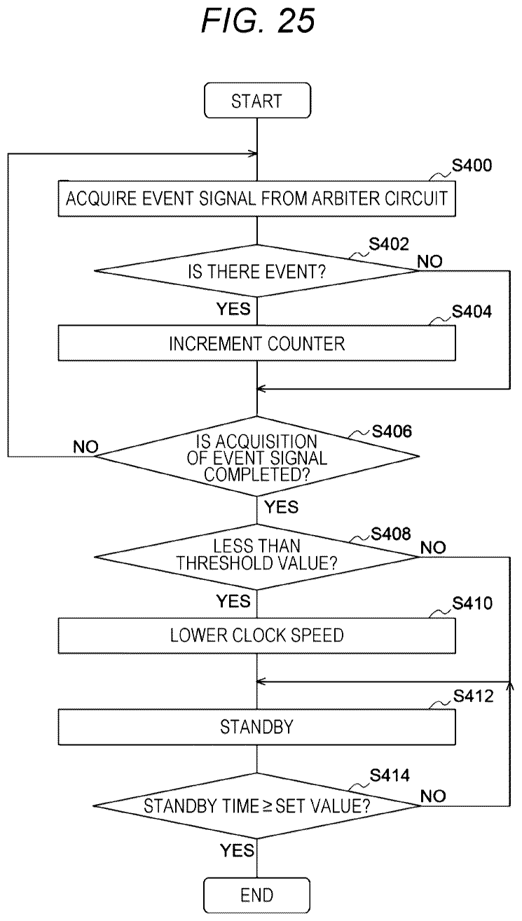

FIG. 25 is a flowchart illustrating an example of processing of the photodetection element 1 according to the embodiment.

The counter 28 acquires the event detection signal from the arbiter 26 (S400).

In a case where there is an event (S402: YES), the counter 28 increments the count value (S404).

After incrementing the count value or in a case where no event has been detected (S402: NO), the counter 28 determines whether or not acquisition of an event signal has been completed (S406).

In a case where the acquisition of the event signal is not completed (S406: NO), the processing is repeated from the processing in S400.

In a case where the acquisition of the event signal is completed (S406: YES), the counter 28 determines whether the count value is less than the threshold value (S408).

In a case where the count value is less than the threshold value (S408: YES), the counter 28 executes the low consumption control on the arbiter 26 and the signal processing circuit 18 (S410). Specifically, the control circuit may perform the low consumption control, for example, by lowering clock frequencies of the arbiter 26 and the signal processing circuit 18. Of course, similarly to the above-described embodiment, the control circuit may control the connection state of the power supply voltage or may control the bias current.

In a case where the count value is equal to or more than the threshold value (S408: NO), the counter 28 transitions to a standby state (S412), and maintains the standby state until the standby time reaches the set value (S414: NO) (S412).

At a timing when the standby time becomes equal to or more than the set value (S414: YES), the one-end processing is completed, and the processing from S400 is repeated again.

In this manner, by providing the arbiter 26 and the counter 28, the photodetection element 1 can execute the low consumption control according to the number of pixels 100 for event detection during arbitration.

### Eleventh Embodiment

In the above-described embodiment, all the pixels 100 individually include the analog unit 110 and the logic unit 112, but the present embodiment is not limited thereto.

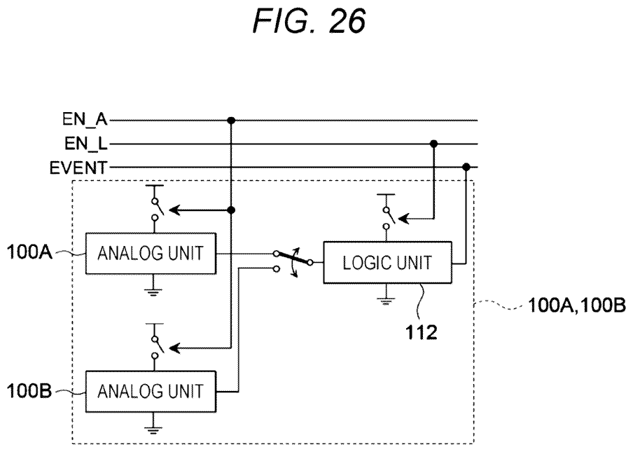

FIG. 26 is a diagram illustrating an example of a pixel according to an embodiment. Pixels 100A and 100B form a pixel block and share some circuits.

The pixel block includes, for example, an analog unit 110A of the pixel 100A, an analog unit 110B of the pixel 100B, and a logic unit 112 shared by the pixels 100A and 100B. The connection between the analog units 110A and 110B and the logic unit 112 is appropriately switched by any switching method. As a non-limiting example, the pixel block may include a transistor for switching the analog unit connected to the logic unit 112.

Note that the pixels 100A and 100B may be in a mode of sharing the logic unit 112 with a part of the analog circuit of the analog unit 110 instead of sharing the logic unit 112. For example, each of the pixels 100A and 100B may include a part of the analog front end, and may share other circuits.

EN_A input to the pixel block is an enable signal for the analog unit in the pixel block, and EN_L is an enable signal for the logic unit. As described above, a plurality of pixels may share a part of the pixel circuit.

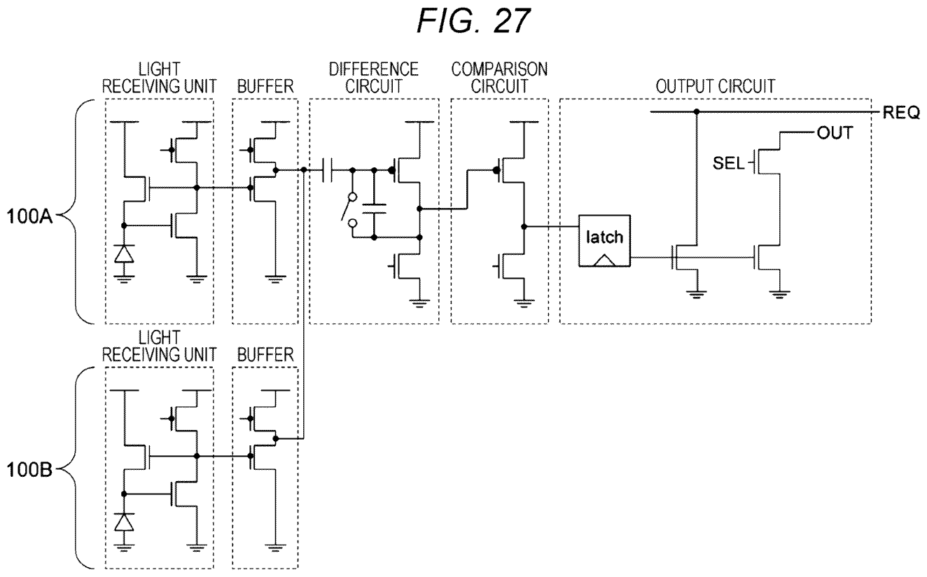

FIG. 27 is a diagram illustrating an example of circuit sharing in pixels. For example, the pixel 100A and the pixel 100B may each include a light receiving unit and a buffer in the analog unit 110, and may share a difference circuit, a comparison circuit, and an output circuit after the difference circuit to form a pixel block.

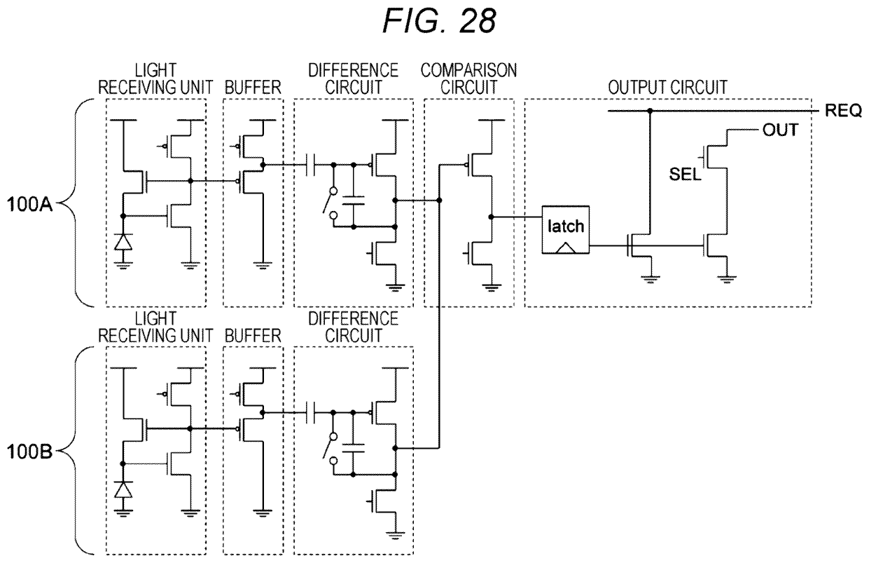

FIG. 28 is a diagram illustrating another example of circuit sharing in the pixel. For example, the pixel 100A and the pixel 100B may include a light receiving unit, a buffer, and a difference circuit in the analog unit 110, and may form a pixel block by sharing a comparison circuit and an output circuit after the comparison circuit.

By sharing a part of the pixel circuit in this manner, the layout area of the pixel circuit can be reduced.

### Twelfth Embodiment

Although the photodetection element 1 in each of the above-described embodiments includes event detection pixels as the pixels 100, the embodiments are not limited thereto. In addition to the event detection pixels, the pixel array 10 may include pixels 100 that acquire another type of information, such as gradation pixels, ToF pixels, image plane phase difference acquisition pixels, polarization state acquisition pixels, and IR information acquisition pixels.

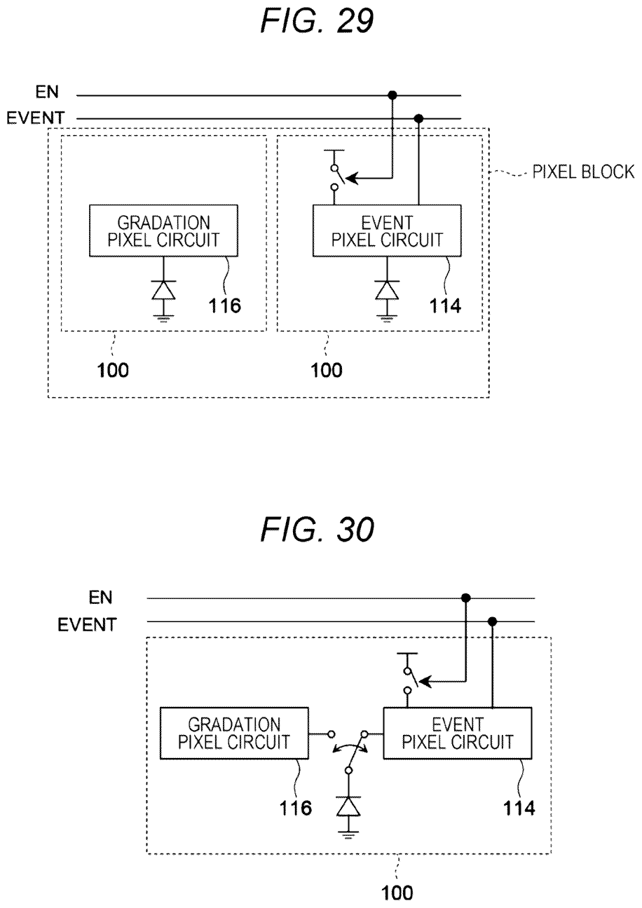

FIG. 29 is a diagram illustrating an example of a pixel according to an embodiment. In the following, description will be given using a gradation pixel that acquires gradation information, but as described above, this gradation pixel (or a part of a pixel circuit) may be replaced with another pixel (or a part of a pixel circuit) such as a ToF pixel, an image plane phase difference pixel, a polarization state pixel, or an IR pixel, or a mode in which a plurality of types of pixels (or a part of a pixel circuit) that are the same or different may be provided together with event detection pixels may be adopted.

The pixel block may include, as pixels 100, a pixel 100 including an event pixel circuit 114 and a pixel 100 including a gradation pixel circuit 116.

The event pixel circuit 114 is a circuit that detects an event in the pixel 100. For example, the pixel 100 in each of the above-described embodiments is a pixel including this event pixel circuit 114.

The gradation pixel circuit 116 is a circuit that acquires gradation information in the pixel 100. The gradation pixel circuit 116 may include any circuit for acquiring gradation used for a general image sensor.

In such a pixel block, the photodetection element 1 can execute the low consumption control for the event pixel circuit 114, similarly to the above-described embodiment. According to this embodiment, it is possible to perform the low consumption control even in a case where the gradation image is acquired and the event information is acquired.

FIG. 30 is a diagram illustrating an example of the pixel 100. As illustrated in this drawing, the photodetection element 1 may be in a mode in which one pixel 100 can operate as an event detection pixel or a gradation pixel by appropriately switching between the event pixel circuit 114 and the gradation pixel circuit 116, instead of including the pixel 100 that acquires event information as a pixel block and the pixel 100 that acquires gradation information. Also in this case, it is possible to perform the low consumption control on the event pixel circuit 114.

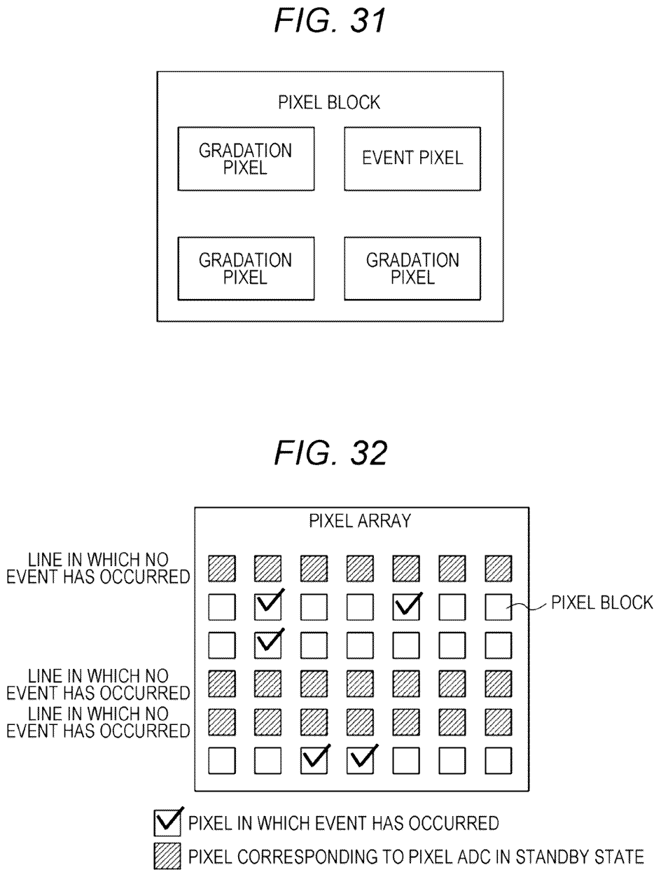

FIG. 31 is a diagram illustrating another example of the pixel block. As illustrated in this drawing, the pixel block may include three or more pixels.

FIG. 32 is a diagram illustrating a state of control in the pixel array 10 in a case of including the pixel block as illustrated in FIG. 31. For the pixel block including a line in which an event has occurred, the control circuit may perform normal control on the event detection pixel and normal control of operation of ADC also on the gradation pixel.

On the other hand, the control circuit may perform the low consumption control on the event detection pixel for the pixel block including a line in which no event is detected, and control processing of pixels to which the ADC and the signal processing circuit 18 correspond to a standby state (low consumption state). This can be applied because, in many cases, there is no change in gradation information or the like captured by the pixel block in the first place in a line in which no event is detected, and thus a large problem does not occur even if the low consumption control is performed for acquisition of gradation information or the like.

As described above, in a line in which no event has occurred, the standby state is set, so that power consumption can be suppressed.

For the pixel 100, in a case where the ADC is necessary, the control circuit can perform the low consumption control by lowering a power supply voltage, a bias voltage, and the like applied to the ADC. The ADC may be a pixel ADC provided for each pixel or an area ADC provided for each predetermined area. In addition, in a case where the low consumption control is performed for each column instead of line control, the control circuit can also perform the low consumption control on the column ADC.

### Thirteenth Embodiment

In the above embodiment, a mode in which the pixel array 10 includes the gradation pixel and the like together with the event detection pixel has been described, but in a case where other types of signals can be acquired as described above, the operation mode of the photodetection element 1 can be set according to the situation of the event.

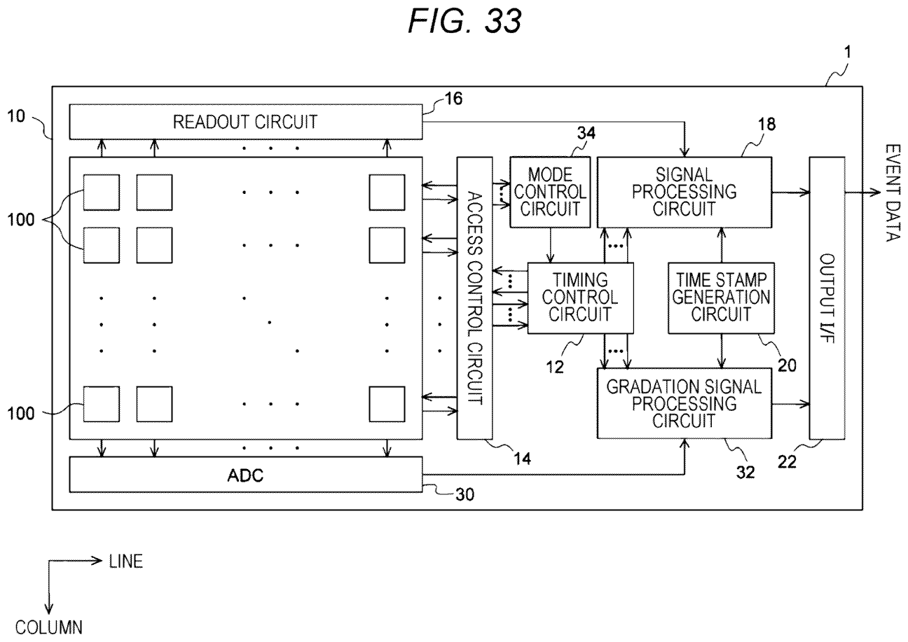

FIG. 33 is a block diagram schematically illustrating a photodetection element according to an embodiment. The photodetection element 1 further includes an ADC 30, a gradation signal processing circuit 32, and a mode control circuit 34 in addition to the configuration of FIG. 1.

The ADC 30 is a circuit that converts an analog signal output from a pixel 100 that requires AD conversion, such as a gradation pixel, into a digital signal and outputs the digital signal.

The gradation signal processing circuit 32 is a circuit that generates a desired digital image signal by performing any signal processing and/or image processing on the digital signal output from the ADC 30.

The mode control circuit 34 is a circuit that switches the imaging mode of the photodetection element 1 according to the state of event detection.

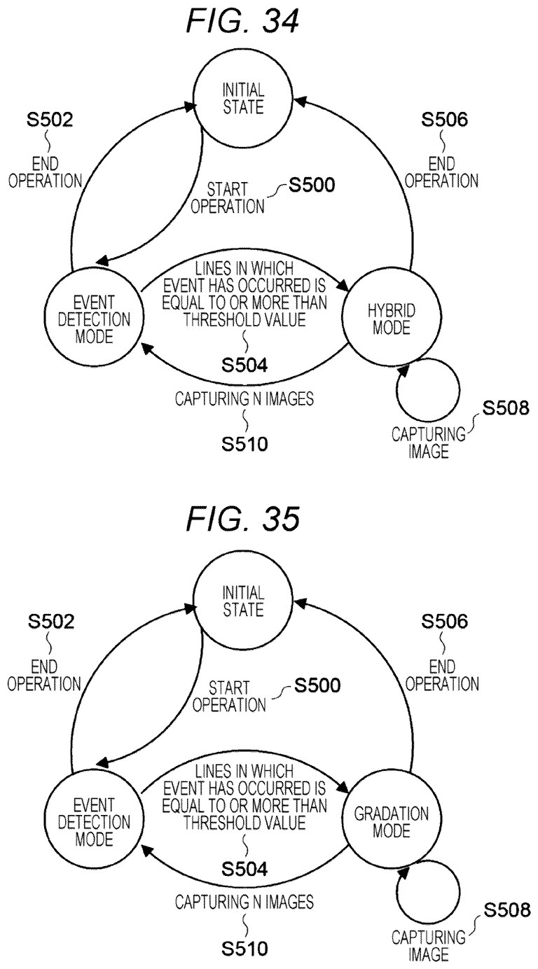

FIG. 34 is a diagram illustrating an example of mode transition of the photodetection element according to the embodiment. In this embodiment, an example of switching between an event detection mode and a hybrid mode for detecting an event and acquiring gradation information will be described.

For example, the photodetection element 1 is set to an initial state in a non-activated state or a standby state in which imaging is not possible. When a start operation is performed from this initial state, the photodetection element 1 transitions to an event detection mode (S500).

When an end operation is performed in the event detection mode, the photodetection element 1 transitions to the initial state (S502).

In a case where the line for event detection is equal to or more than the predetermined threshold value, the photodetection element 1 transitions to a hybrid mode in which gradation information is acquired together with event detection (S504). In the hybrid mode, it is possible to detect an event and capture a gradation image at any timing.

In the hybrid mode, when an end operation is performed, the photodetection element 1 transitions to the initial state (S506).

In a case where the gradation image is captured in the hybrid mode, the photodetection element 1 transitions to the hybrid mode again (S508). In this case, after a predetermined number, for example, N images are captured, the mode may transition to the event detection mode (S510).

FIG. 35 is a diagram illustrating another example of the mode transition of the photodetection element. As illustrated in this drawing, the photodetection element 1 may include a gradation mode instead of a hybrid mode for detecting an event and acquiring gradation information.

As illustrated in FIG. 35, the photodetection element 1 may transition from the event detection mode to the gradation mode on the basis of the firing rate of the event, similarly to FIG. 34 described above.

As still another example, the photodetection element 1 may be in a mode of switching three modes of the event detection mode, the hybrid mode, and the gradation mode on the basis of the firing rate of the event detection pixel.

As described above, the photodetection element 1 can also switch the drive mode on the basis of the firing rate of the event detection pixel. Also in this case, as in the above-described embodiment, it is possible to execute the low consumption control on the basis of the determination criterion or the application range criterion of the low consumption control for each line, each column, each group, or the like, and it is possible to reduce the power consumption even in applications other than the event detection such as acquiring the gradation.

### Fourteenth Embodiment

In a case where the event detection pixel and the gradation pixel and the like are mounted in a mixed manner, it is also possible to control the ADC or the like as described above. In the present embodiment, control of the column ADC will be described with an example.

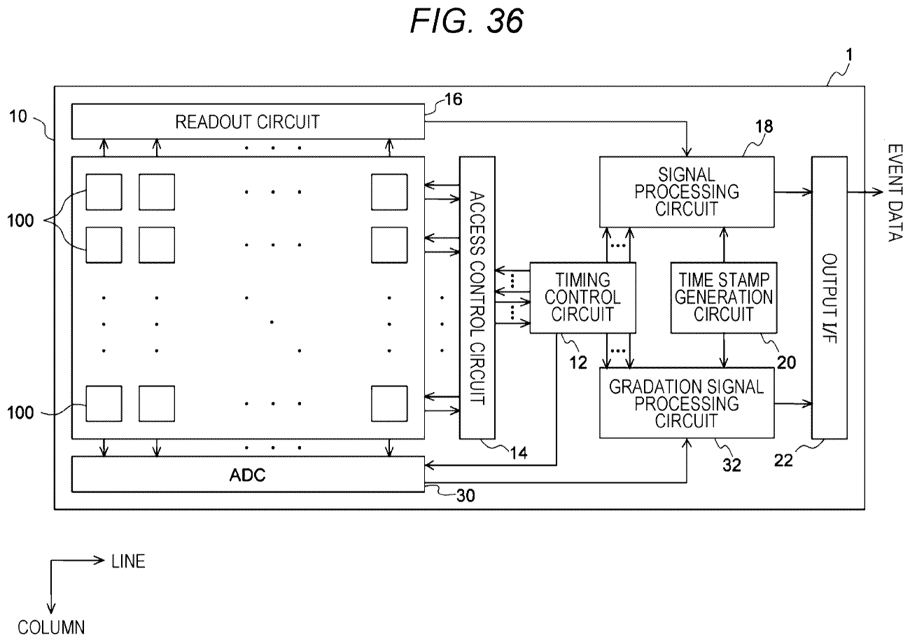

FIG. 36 is a block diagram schematically illustrating a photodetection element according to an embodiment. Compared with the configuration of the above-described embodiment, the mode control circuit 34 is not provided.

The access control circuit 14 H notifies the timing control circuit 12 of information regarding a line for which no event has been detected. The timing control circuit 12 notifies the ADC 30 and the gradation signal processing circuit 32 of the received line information.

On the basis of the information of the line, the ADC 30 may perform, for example, the low consumption control of the column ADC, and the gradation signal processing circuit 32 may perform the low consumption control in an appropriate area for signal processing.

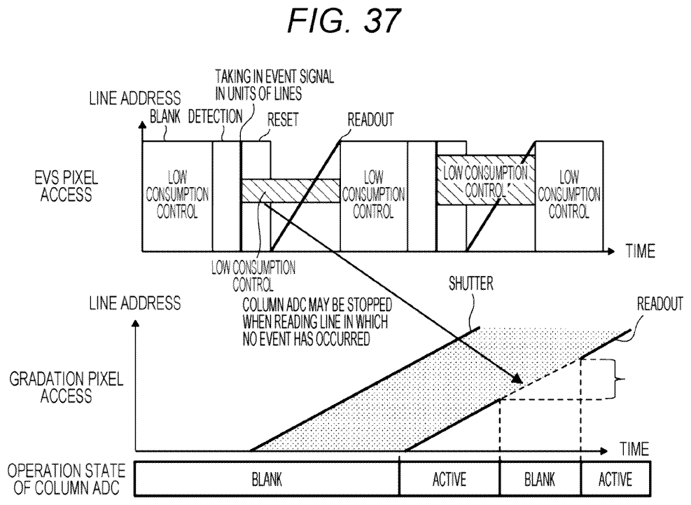

FIG. 37 is a diagram illustrating an example of a relationship between a state of a line and time according to an embodiment. The operation of the event detection pixel is basically the same as the operation of FIG. 7, but the operation of the peripheral pixels related to the gradation pixels is also controlled according to the state of the event detection of the event detection pixel.

The control circuit notifies the timing control circuit 12 of information of the line from the access control circuit 14 for the line on which the low consumption control has been performed in the event detection pixel. Based on this notification, the timing control circuit 12 performs the low consumption control of the ADC 30 at the timing of controlling the line on which the low consumption control has been performed.

At this timing, conversion into a digital signal by the ADC 30 is unnecessary, for example, information of the previous frame can be used, and thus, by controlling the power supply voltage or the like applied to the ADC 30, power consumption can be reduced without greatly affecting the gradation image.

Note that this low consumption control can also be executed for each line, for each column, for each group, or for each pixel, as in the above-described embodiment.

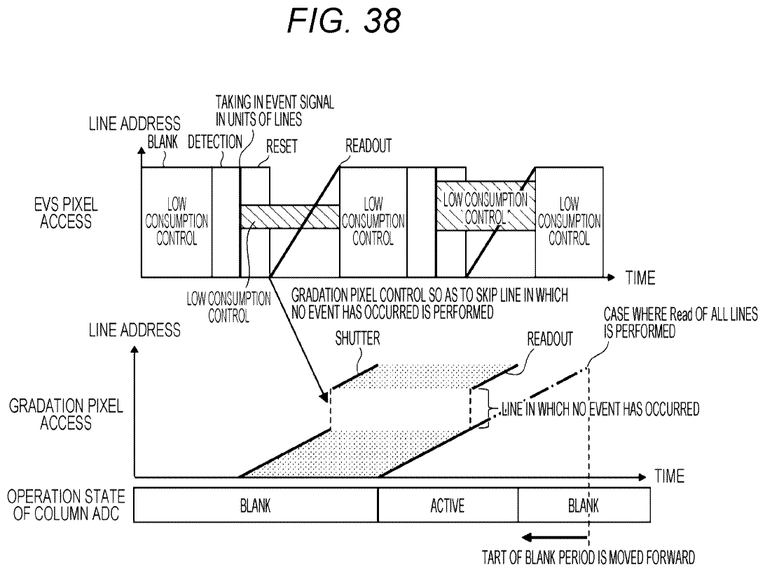

FIG. 38 is a diagram illustrating another example of the relationship between the state of the line and the time. In addition to the case of FIG. 37, low consumption control of a shutter is further executed. The control circuit can skip the operation of the shutter for a line for which event detection has not been performed, and skip AD conversion for a line for which information has not been acquired by shutter control to read the gradation information.

In this case, as illustrated in the drawing, since the blank period in the next frame can be moved forward, the frame rate can also be improved.

Thus, the control circuit may read the event and read the gradation information from a line in which an event has occurred. As described above, the frame rate of imaging can be improved, and the power consumption can be reduced.

The photodetection element 1 in the present disclosure can be mounted on various electronic devices. For example, an electronic device can be configured by combining the photodetection element 1, an external signal processing circuit, and another external processing circuit.

The external signal processing circuit executes, for example, signal processing based on a signal related to the event output from the photodetection element. The external processing circuit executes arbitrary processing on the basis of a signal output from an external signal processing circuit. For example, the photodetection element 1 can be included in an electronic device that implements processing in various devices as described below.

The technology according to the present disclosure can be applied to various products. For example, the technology according to the present disclosure may also be implemented as a device mounted on any kind of moving body such as an automobile, an electric automobile, a hybrid electric automobile, a motorcycle, a bicycle, a personal mobility, an airplane, a drone, a ship, a robot, a construction machine, an agricultural machine (tractor), or the like.

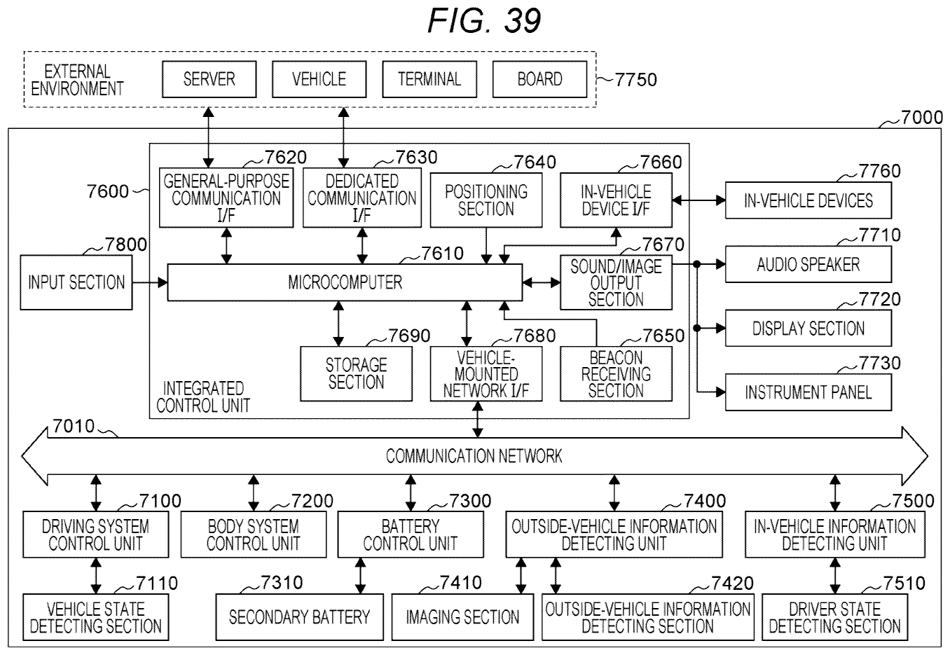

FIG. 39 is a block diagram illustrating an example of schematic configuration of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 39, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. Functional components of the integrated control unit 7600 illustrated in FIG. 39 include a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

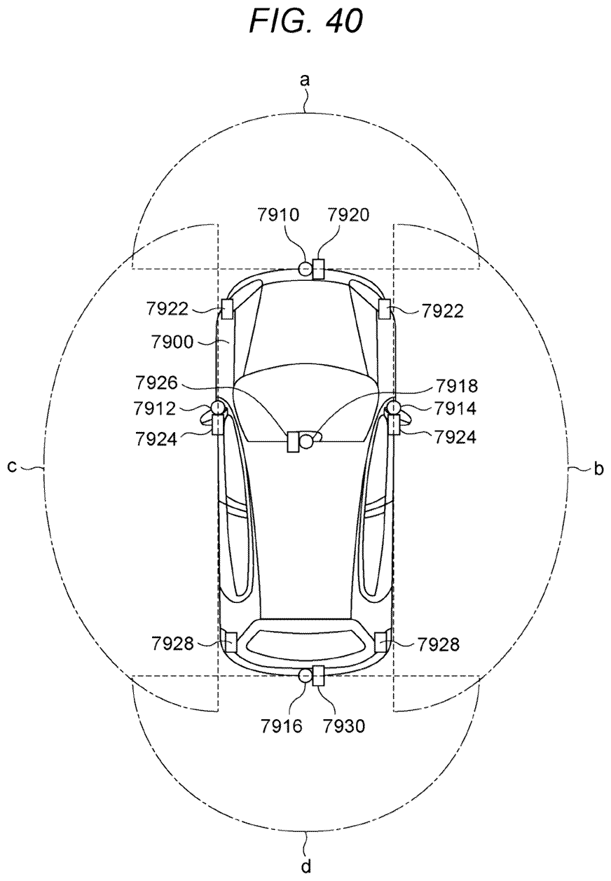

Here, FIG. 40 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 40 illustrates an example of the imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 39, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010.

The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 39, an audio speaker 7710, a display section 7720, and an instrument panel 7730 are illustrated as output devices. The display section 7720 may, for example, include at least one of an on-board display and a head-up display.

The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that at least two control units connected to each other via the communication network 7010 in the example illustrated in FIG. 39 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing some functions of the photodetection element 1 according to the present embodiment described with reference to FIGS. 1 to 38 can be mounted on any control unit or the like. Furthermore, a computer-readable recording medium in which such a computer program is stored can be provided. The recording medium is, for example, a magnetic disk, an optical disc, a magneto-optical disk, a flash memory, or the like. In addition, the computer program described above may be distributed via, for example, a network without using a recording medium.

The embodiment described above may have the following forms.

### 1

A photodetection element including:
a pixel array in which event detection elements that detect an intensity difference of received light are arranged in a two-dimensional array;
a holding circuit that holds an event detected by the event detection elements;
a control circuit that controls a power supply voltage and a clock signal for the event detection element belonging to at least a partial region of the pixel array and the holding circuit corresponding to the event detection element; and
a signal processing circuit that processes a signal output from the event detection element.

### 2

The photodetection element according to (1), in which
the pixel array includes the event detection elements arranged in a two-dimensional array continuous in a line direction and a column direction intersecting the line direction,
the holding circuit holds the event for each of lines in the pixel array, and
the control circuit
   selects the event detection pixels that are continuous in the line direction in the pixel array and drives the event detection elements belonging to the selected line, and
   controls the power supply voltage and the clock signal of the event detection elements for each of the lines on the basis of the event held for each of the lines.

### 3

The photodetection element according to (2), in which
the control circuit controls, for each of the lines, a bias voltage related to the event detection elements, and the power supply voltage and the clock signal of the signal processing circuit related to the event detection elements.

### 4

The photodetection element according to (2) or (3), in which
the control circuit controls the power supply voltage of the event detection elements on the basis of the event output for each of one or a plurality of lines.

### 5

The photodetection element according to (4), in which
the control circuit divides the event detection elements belonging to the one or the plurality of lines into a plurality of groups, and controls the event detection elements for each of the groups.

### 6

The photodetection element according to (2) or (3), in which
the control circuit controls the power supply voltage of the event detection elements on the basis of the event output for each of one or a plurality of columns.

### 7

The photodetection element according to (6), in which
the control circuit divides the event detection elements belonging to the one or the plurality of columns into a plurality of groups, and controls the event detection elements for each of the groups.

### 8

The photodetection element according to (2), in which
the control circuit controls the power supply voltage for each of the event detection pixels.

### 9

The photodetection element according to (2), in which
the control circuit controls the power supply voltage on the basis of the event information in a past frame.

### 10

The photodetection element according to any one of (1) to (9), in which
the pixel array further includes a gradation information acquisition element that acquires gradation information.

### 11

The photodetection element according to any one of (1) to (10), in which
the pixel array further includes an element that acquires time of flight (ToF) information.

### 12

The photodetection element according to any one of (2) to (11), in which
the control circuit performs standby control on a line in which the event has not occurred.

### 13

The photodetection element according to any one of (2) to (12), in which
the control circuit switches a drive mode on the basis of a firing rate of the event of the event detection elements.

### 14

The photodetection element according to any one of (2) to (13), in which
the control circuit switches processing of a column analog to digital converter (ADC) on the basis of an occurrence state of the event in a line to be read.

### 15

The photodetection element according to any one of (2) to (14), in which
the control circuit reads the event from a line on which the event has occurred.

### 16

The photodetection element according to any one of (1) to (15), in which
the event detection elements share an analog front end.

### 17

The photodetection element according to (16), in which
the event detection elements shares a difference circuit and a comparison circuit.

### 18

The photodetection element according to (16), in which
the event detection elements shares a comparison circuit.

### 19

The photodetection element according to (16), in which
the event detection elements shares a circuit connected to the power supply voltage.

### 20

The photodetection element according to any one of (1) to (19), in which
the control circuit executes clock control of a peripheral circuit on the basis of a signal related to the event detected by the event detection elements.

### 21

The photodetection element according to (20), in which
the control circuit switches a clock frequency of the peripheral circuit on the basis of a signal related to the event.

### 22

An electronic device including:
the photodetection element according to any one of (1) to (21);
a signal processing circuit that executes signal processing based on a signal related to the event output from the photodetection element; and
an external processing circuit that executes arbitrary processing on the basis of a signal output from the signal processing circuit.

### 23

The electronic device according to (22), in which
the electronic device is an in-vehicle device.

Aspects of the present disclosure are not limited to the above-described embodiments but include various conceivable modifications, and the effects of the present disclosure are not limited to the above-described contents. The components in each of the embodiments may be appropriately combined and applied. That is, various additions, modifications, and partial deletions can be made without departing from the conceptual idea and gist of the present disclosure derived from the contents defined in the claims and equivalents and the like thereof.

### REFERENCE SIGNS LIST

1 Photodetection element
10 Pixel array
100 Pixel
102 Light receiving element
104 Detection circuit
106 Storage circuit
110 Analog unit
112 Logic unit
114 Event pixel circuit
116 Gradation pixel circuit
12 Timing control circuit
14 Access control circuit
140 Low consumption control circuit
142 Event holding unit
144 Line control circuit
146 Column control circuit
148 Event counter
150 Comparison unit
152 Power supply control circuit
16 Readout circuit
18 Signal processing circuit
20 Time stamp generation circuit
22 Output I/F
24 Bias generation circuit
26 Arbiter
28 Counter
30 ADC
32 Gradation signal processing circuit
34 Mode control circuit

1. A photodetection element comprising:
a pixel array in which event detection elements that detect an intensity difference of received light are arranged in a two-dimensional array;
a holding circuit that holds an event detected by the event detection elements;
a control circuit that controls a power supply voltage and a clock signal for the event detection element belonging to at least a partial region of the pixel array and the holding circuit corresponding to the event detection element; and
a signal processing circuit that processes a signal output from the event detection element.

2. The photodetection element according to claim 1, wherein
the pixel array includes the event detection elements arranged in a two-dimensional array continuous in a line direction and a column direction intersecting the line direction,
the holding circuit holds the event for each of lines in the pixel array, and
the control circuit
selects the event detection elements that are continuous in the line direction in the pixel array and drives the event detection elements belonging to the selected line, and
controls the power supply voltage and the clock signal of the event detection elements for each of the lines on a basis of the event held for each of the lines.

3. The photodetection element according to claim 2, wherein
the control circuit controls, for each of the lines, a bias voltage related to the event detection elements, and the power supply voltage and the clock signal of the signal processing circuit related to the event detection elements.

4. The photodetection element according to claim 2, wherein
the control circuit controls the power supply voltage of the event detection elements on a basis of the event output for each of one or a plurality of lines.

5. The photodetection element according to claim 4, wherein
the control circuit divides the event detection elements belonging to the one or the plurality of lines into a plurality of groups, and controls the event detection elements for each of the groups.

6. The photodetection element according to claim 2, wherein
the control circuit controls the power supply voltage of the event detection elements on a basis of the event output for each of one or a plurality of columns.

7. The photodetection element according to claim 6, wherein
the control circuit divides the event detection elements belonging to the one or the plurality of columns into a plurality of groups, and controls the event detection elements for each of the groups.

8. The photodetection element according to claim 2, wherein
the control circuit controls the power supply voltage for each of the event detection elements.

9. The photodetection element according to claim 2, wherein
the control circuit controls the power supply voltage on a basis of information of the event in a past frame.

10. The photodetection element according to claim 1, wherein
the pixel array further includes a gradation information acquisition element that acquires gradation information.

11. The photodetection element according to claim 1, wherein
the pixel array further includes an element that acquires time of flight (ToF) information.

12. The photodetection element according to claim 2, wherein
the control circuit performs standby control on a line in which the event has not occurred.

13. The photodetection element according to claim 2, wherein
the control circuit switches a drive mode on a basis of a firing rate of the event of the event detection elements.

14. The photodetection element according to claim 2, wherein
the control circuit switches processing of a column analog to digital converter (ADC) on a basis of an occurrence state of the event in a line to be read.

15. The photodetection element according to claim 2, wherein
the control circuit reads the event from a line on which the event has occurred.

16. The photodetection element according to claim 1, wherein
the event detection elements share an analog front end.

17. The photodetection element according to claim 16, wherein
a plurality of the event detection elements shares
a difference circuit and a comparison circuit,
a comparison circuit, or
a circuit connected to the power supply voltage.

18. The photodetection element according to claim 1, wherein
the control circuit executes clock control of a peripheral circuit on a basis of a signal related to the event detected by the event detection elements.

19. The photodetection element according to claim 18, wherein
the control circuit switches a clock frequency of the peripheral circuit on a basis of a signal related to the event.

20. An electronic device comprising:
the photodetection element according to claim 1;
a signal processing circuit that executes signal processing based on a signal related to the event output from the photodetection element; and
an external processing circuit that executes arbitrary processing on a basis of a signal output from the signal processing circuit.
